(19) United States
(12) Patent Application Publication
(10) Pub. No.: US 2026/0357360 A2
(43) Pub. Date: Nov. 12, 2026

(54) METHOD FOR OPERATING A SMELTING FURNACE INSTALLATION

(71) Applicant: PAUL WURTH S.A., Luxembourg (LU)

(72) Inventors: Klaus Peter KINZEL, Sandweiler (LU); Fernand DIDELON, Bettembourg (LU); Mehdi BANIASADI, Helmsange (LU); Evangelos DELIKONSTANTIS, Luxembourg (LU); Jihong JI, Steinfort (LU)

(21) Appl. No.: 19/107,282

(22) PCT Filed: Aug. 29, 2023
(86) PCT No.: PCT/EP2023/073711

§ 371 Date: Feb. 27, 2025

(30) Foreign Application Priority Data
Aug. 29, 2022 (DE) 10 2022 121 807.4
Aug. 29, 2022 (LU) LU502719

(51) Int. Cl. C21B 5/06; C21B 7/16

(52) U.S. Cl. CPC C21B 5/06; C21B 7/163; C21B 2100/22; C21B 2100/26; C21B 2100/28

(57) ABSTRACT

A method for operating a smelting furnace installation, in particular a blast furnace installation, the method including the following steps: feeding coke, iron oxide containing material and if required fluxing agents to the top of the smelting furnace; injecting a first reducing gas containing hydrogen at a tuyere level of the smelting furnace at a temperature above 1600 °C; and injecting a second reducing gas at a lower shaft level of the smelting furnace. The coke is fed at a lump coke rate below 220 kg/t HM, and the density of the first reducing gas is below 0.80 kg/Nm³.

### CROSS-REFERENCE TO RELATED APPLICATIONS

This application is a 35 U.S.C. § 371 National Stage patent application of PCT/EP2023/073711 filed 29 Aug. 2023, which claims the benefit of both Luxembourg patent application 502 719 filed 29 Aug. 2022 and German patent application 10 2022 121 807.4 filed 29 Aug. 2022, the disclosures of which are incorporated herein by reference in their entirety.

### TECHNICAL FIELD

The present disclosure generally relates to a method for operating a smelting furnace installation, in particular a blast furnace installation, as well as to such a smelting or blast furnace installation.

### BACKGROUND

One of the major concerns of smelting furnace installations nowadays is their CO₂ emissions which inevitably seem associated to the very functioning of such smelting/blast furnaces. Conversely, steel production is a key element for reducing these emissions since it provides the raw material for the construction of the CO₂ lean technologies.

Despite alternative methods and installations, like scrap melting or a direct reduction process followed by melting in an electric arc furnace, the smelting (i.e. reduction and melting) furnace, such as the blast furnace (BF), today still represents the most widely used process for steel production.

Indeed, the blast furnace has a long tradition in iron and steel making due to its versatility, mainly with respect to the utilization of all kind of iron bearing materials. Its drawback comes from the fact that it uses high amounts of carbon brought by coke and/or auxiliary fuels for the reduction of the ore and for the supply of the high flame temperature of >1800 °C required to supply the energy required for reduction, heating and melting of the iron and gangue.

Furthermore, the coke represents a solid matrix in the furnace allowing a sufficient gas permeability in the lower part of the furnace, where the partly reduced iron ore is heated to its melting temperature and then molten in the so-called cohesive zone. In the cohesive zone, the ore material is softening and losing most of its permeability. In the cohesive zone, the gas therefore mainly passes through the coke layers arranged in this zone. Below the cohesive zone is the dripping zone, in which the molten material drips down in counter/cross flow with the ascending reducing gas flow. In order that this happens correctly in both zones, the forces exercised by the upstreaming gas on the downflowing droplets must be within certain operational conditions.

Today it is believed that the minimum coke rate in the blast furnace is about 220 kg/t HM. This limitation is not coming from process reasons, but from the above-mentioned mechanical and/or fluid dynamics restrictions.

As a matter of fact, some proposals have been made many years ago to reduce the coke rate to even below 100 kg/t HM. Such process proposals for very low coke rates have however never been adopted by steel industry, since there are a number of issues that have to be overcome if such low coke rates are actually to be achieved.

In fact, these issues might appear in different zones of a smelting furnace, such as in particular a blast furnace.

In an iron making blast furnace for example, the iron oxide containing material descends through the furnace, undergoing processes of reduction, softening, melting and dripping onto the hearth. At temperatures between the start of softening and complete melting they form the cohesive zone. In this cohesive zone, when using decreasing coke rates, the passage volume for the ascending gas is becoming problematic. The reason is that the relative thickness of ore layers increases, and the number of coke layers in the cohesive zone decreases. This, in turn, raises the gas velocity and subsequently the pressure drop in the cohesive zone.

As the velocity of the ascending gas in the cohesive zone becomes higher, it has the tendency to spread horizontally towards the wall area and to flow upward in the wall area following the path of least resistance. This adverse effect known as wall channeling phenomenon causes heat loss, preferential gas flow through the burden and as consequence uneven burden reduction degree and temperature leading to severe operation disturbances.

Furthermore, an increase in the bosh gas velocity can prevent the liquid metal and slag from flowing downwards inside the dripping zone, causing the flooding phenomenon.

In the blast furnace shaft, the reduction of the coke rate to very low values will have an important impact on the void space of the solid charge. Due to the smaller size of iron ore particles with a broader size distribution, they form less void space as compared to the big coke particles. The resulting void space among the coke particles is approximately 50%, whereas for the iron ore particles it is on average only about 35%. In the case of very low coke rates, the proportion of ore particles is very high and thus the void space of the shaft will be substantially decreased, leading to a high gas pressure drop within the shaft. This can lead to the so-called hanging phenomenon, where the burden materials do not move continuously downward, and they meet a very high resistance (very high gas pressure drop).

Finally, a minimum coke rate is also required to ensure proper carburizing of the hot metal. Indeed, maintaining carbon content stable is an important prerequisite to ensure the further transformation step of iron to steel.

### SUMMARY

The present disclosure provides a method of operating a smelting furnace installation, in particular a blast furnace installation, which permits to significantly reduce CO₂ emissions, while allowing to appropriately deal with the above-mentioned issues.

In order to overcome the above-mentioned problem, the present disclosure proposes, in a first aspect, a method for operating a smelting (shaft) furnace installation, such as a blast furnace installation, wherein the method comprises the steps of
feeding coke, iron oxide containing and other iron bearing material (such as iron ore, Hot Briquetted Iron (HBI), scrap, etc.) and, if required, fluxing agents to the top of the smelting furnace,
injecting a first reducing gas containing hydrogen at a tuyere level of the smelting furnace at a temperature above 1600 °C, and
injecting a second reducing gas at a lower shaft level of the smelting furnace.
   According to the disclosure, coke is fed at a lump coke rate below about 220 kg/t HM, such as below about 200 kg/t HM, below about 180 kg/t HM, below about 160 kg/t HM, below about 150 kg/t HM or below about 140 kg/t HM and most preferably below about 130 kg/t HM and wherein the density of the first reducing gas is below about 0.80 kg/Nm³, preferably below about 0.70 kg/Nm³, more preferably below about 0.60 kg/Nm³, such as below about 0.50 kg/Nm³, below about 0.45 kg/Nm³, below about 0.35 kg/Nm³, and most preferably below about 0.30 kg/Nm³.

In a second aspect, the disclosure proposes a smelting furnace installation, in particular a blast furnace installation, comprising
a charging apparatus configured for feeding coke, iron oxide containing and other iron bearing material (such as iron ore, Hot Briquetted Iron (HBI), scrap, etc.) and, if required, fluxing agents to the top of the smelting furnace,
a first injector arrangement positioned at a tuyere level of the smelting furnace and configured for injecting a first reducing gas containing hydrogen at said tuyere level of the smelting furnace at a temperature above 1600 °C,
a second injector arrangement positioned at a shaft level of the smelting furnace and configured for injecting a second reducing gas at a lower shaft level of the smelting furnace,
   wherein the charging apparatus is configured for feeding coke at a lump coke rate about 220 kg/t HM, such as below about 200 kg/t HM, below about 180 kg/t HM, below about 160 kg/t HM, below about 150 kg/t HM or below about 140 kg/t HM and most preferably below about 130 kg/t HM, wherein the first injector arrangement is configured for injecting the first reducing gas with a density below about 0.80 kg/Nm³, preferably below about 0.70 kg/Nm³, more preferably below about 0.60 kg/Nm³, such as below about 0.50 kg/Nm³, below about 0.45 kg/Nm³, below about 0.35 kg/Nm³, and most preferably below about 0.30 kg/Nm³ and wherein said first injector arrangement comprises an electric heating device configured for heating the first reducing gas at said temperature above 1600 °C. Hence, said smelting furnace installation is preferably adapted and configured for implementing the method according to the first aspect.

Starting from the premise that substantially reducing the coke rate would lead to a reduced permeability of the cohesive zone, the inventors devised that by injecting a second reducing gas into the shaft area (reference B in FIG. 3), the actual flow rate of reducing gas going through the channels of the cohesive zone (i.e. the first reducing gas, reference A in FIG. 3) could in principle be significantly reduced, thereby also reducing its velocity. As both velocity and volume flow rate of bosh gas would be decreased, the upward force exerted on the slag and iron droplets would be decreased and the risk of flooding would be reduced. More importantly however, the inventors conceived that another way to reduce the actual mass flow through the cohesive zone would be to use a less dense gas as a first reducing gas. The density of the first reducing gas can be controlled by decreasing its content of denser species, such as carbon dioxide, nitrogen, water, etc. and/or by increasing its content in less dense species, such as in particular by increasing its hydrogen content or by introducing helium to the first reducing gas. This inventive way of “circumventing” the permeability issues in the cohesive zone in turn also allows to largely prevent the phenomenon of hanging in the burden above and significantly reduce the risk of flooding in the dripping zone. Moreover, the injection of the second reducing gas above the cohesive zone pushes the ascending first reducing gas towards the center of the smelting furnace (as illustrated in FIG. 3), which in turn reduces the wall channeling issue mentioned above. Furthermore, injecting the first reducing gas at temperatures above 1600 °C allows to provide a substantial proportion of the thermal energy required for heating and melting the burden.

While the introduction of less dense species such as hydrogen, helium or mixtures thereof allow for reducing the actual mass flow of the (first) reducing gas, it will also allow for providing the required thermal energy. Indeed, as shown in the following table, the specific heat capacities of helium and especially hydrogen (here at about the temperatures of interest: about 1527 °C) are significantly greater than for other gases, such as e.g. CO or N₂, meaning that the amount of heat that is released per unit of mass of hydrogen or helium in order to cause a decrease of one unit in temperature is much higher.

TABLE
Specific heat capacity of different gases

| | CO | H2 | N2 | He |
|---|---|---|---|---|
| Cp (kJ/kg · K) at 1800K | 1.28 | 16.76 | 1.27 | 10.39 |

Yet, among helium and hydrogen, the latter is particularly preferred, as beyond its role as an efficient thermal vector, it moreover has a reduction potential directly useful within the blast furnace.

Having said this, the concomitant injection of the second reducing gas (and an appropriate control thereof) at the lower shaft level does therefore also allow to at least maintain or preferably increase the production of hot metal compared to more conventionally operated blast furnaces. Alternatively, or additionally, the injection of the second reducing gas (and an appropriate control thereof) at the lower shaft level allows for decreasing the lump coke rate to values below 160 kg/t hot metal.

In embodiments, the second reducing gas may have a density slightly higher than the first reducing gas, however it is preferred that the density of the second reducing gas be lower than 1.2 kg/Nm³, preferably below 1.0 kg/Nm³, more preferably below 0.9 kg/Nm³.

In embodiments, the first reducing gas may be injected at a pressure of between 2 bar absolute and 10 bar absolute, preferably between 4 and 5 or even 5 and 6 bar absolute. According to the same or other embodiments, the second reducing gas may be injected at a pressure of between 2 and 10 bar absolute, preferably between 4 and 5 bar absolute.

While the present method does not preclude burning coke to produce both heat and reducing species, it generally is advantageous to decrease the injection of oxygen e.g. from rates above about 300 Nm³/t HM or even above about 250 Nm³/t HM or above about 200 Nm³/t HM to low to very low flow rates. Hence, in particularly preferred embodiments, the method further comprises the step of
injecting oxygen at the tuyere level of the smelting furnace at a rate below about 180, 160 or 140 Nm³/t HM, such as below about 120 Nm³/t HM, preferably below about 112 Nm³/t HM and more preferably below about 100 Nm³/t HM, such as below about 80, 40 or even 20 Nm³/t HM.

Advantageously, the temperature of the injected oxygen is below 600 °C and preferably below about 400 °C, such as below about 300 °C, below about 200 °C or even at about ambient temperature. The oxygen is preferably injected in concentrated form, such as with an oxygen content of at least about 75 vol.-%, more preferably at least about 90 vol.-% or at least about 95 vol.-%, such as industrially pure oxygen.

As mentioned above, while it is desirable to reduce the amount of oxygen injected at tuyere level, not only to limit the actual amount of gas going through the channels of the cohesive zone, but also to burn as little coke as possible, the inventors found that the raceways, i.e. the void spaces generally found in front of the tuyeres in blast furnaces operated with oxygen containing hot blast, whose role is an appropriate distribution of the gas within the bosh of the blast furnace, can be obtained mechanically by high injection gas velocity for example above 150 m/s, more preferably above 170 m/s, and even more preferably above 200 m/s in case no oxygen is injected at tuyere level (and thus no coke is burned in front of the tuyeres). It is noteworthy that in the present disclosure, the raceway formation is also at least partially due to a direct gasification of coke by the effect of the injected very hot first reducing gas, as will be explained in more detail below. However, both this mechanical action and the contribution of direct coke gasification of the injected first reducing gas might not be sufficient to “blow” a satisfactory void in front of the tuyeres, such that it might be desirable or necessary to inject relatively small amounts of oxygen compared to flow rates usual in conventional hot blast operated blast furnaces. Hence, in the present method it may be advantageous to inject “raceway-creating”, “raceway-sustaining” or “raceway-supporting” amounts of oxygen, i.e. amounts of oxygen sufficient to create or sustain the size and shape of the raceway behind the point of injection of the first reducing gas by burning appropriate amount of coke in this area or amounts of oxygen sufficient to support or complement the mechanical and gasification effects described above. The injection of oxygen may be continuous or intermittent or even individually controlled to the actual needs regarding the size and shape of the raceway. In embodiments with oxygen injection, the flame temperature may be regulated to temperatures between 1700 and 2600 °C, preferable between 1800 and 2400 °C, more preferable between 1800 and 2300 °C.

In the present context, it seems clear that a “blast furnace” when operated according to the disclosure is actually not a “blast” furnace as such, because the present disclosure basically replaces the blast with a first reducing gas as defined herein. However, for the sake of convenience, the expression “blast furnace” when used herein can refer to furnaces operated with air/oxygen containing blast in the context of conventionally (operated) shaft reduction and melting (smelting) furnaces or to shaft reduction and melting furnaces operated as described herein, wherein the blast is essentially replaced with a reducing gas, called first reducing gas herein.

In general, the first reducing gas will be injected at the tuyere level at rates below about 800 kg/t HM, preferably below about 775 kg/t HM, below about 750 kg/t HM, below about 700 kg/t HM, below about 650 kg/t HM and most preferably below about 600 kg/t HM. For lower lump coke rates, the mass flow of the injection at the tuyeres will generally be lower. However, as a minimal flow rate for the first reducing gas must be ensured, the first reducing gas may preferably be injected at mass flow rates above 60 kg/t HM, preferably above 120 kg/t HM, above 180 kg/t HM, or even above 300 kg/t HM. In embodiments, the first reducing gas may be injected at a volume flow rate between 500 and 1300 Nm³/t HM, preferably between 900 and 1300 Nm³/t HM, more preferably between 770 and 1000 Nm³/t HM.

The second reducing gas may be injected at mass flow rates above 20 kg/t HM, preferably above 50 kg/t HM, however it is preferred that the second reducing gas be injected at rates below 600 kg/t HM, preferably below 400 kg/t HM or even below 360 kg/t HM. Additionally or alternatively, the second reducing gas may be injected at volume flow rates between 200 and 800 Nm³/t HM, preferably between 250 and 700 Nm³/t HM, more preferably between 250 and 600 Nm³/t HM.

The first reducing gas and/or the second reducing gas useable in the present method usually comprise syngas. While this syngas can be obtained from any appropriate process or sources, the present method preferably comprises the further step of producing such syngas by a reforming step, in particular the reforming of coke oven gas, natural gas and/or other (lower) hydrocarbons or mixtures thereof, especially by reforming them with CO₂ and/or H₂O. Preferably, the supply of these components might result from reforming from the utilization of the smelting furnace's (own or not own) top gas, basic oxygen furnace (BOF) gas, open bath furnace (OBF) or other offgases and process gases from the steel plant. It might also be suitable to use hot oxygen for the reforming of the hydrocarbon resulting from the combustion of steel plant by-products such as tar, coke breeze or others into pure oxygen. Other appropriate processes include submitting smelting furnace top gas and/or coke oven gas and/or BOF gas and/or OBF gas to absorption with monoethanolamine (MEA), membrane separation, Pressure Swing Adsorption (PSA) or Vacuum Pressure Swing Adsorption (VPSA). Reforming can be done by any appropriate catalytic or non-catalytic reforming process or a combination of more of such processes, such as steam reforming, dry reforming, etc. depending on the starting materials. Advantageously, the top gas of the smelting furnace is used as CO₂ and/or H₂O source in the hydrocarbon reforming and can thus be recycled in the preparation of the first and/or second reducing gases. Additionally or alternatively, the reducing gas may also be produced from a hydrocarbon source using a technology of autogenous reforming or partial oxidation.

According to preferred embodiments of the disclosure, the first reducing gas contains hydrogen. Indeed, the inventors found that in order to alleviate the issues with the reduced void when reducing coke rates and in particular the permeability issues in the cohesive zone, and concomitantly decrease the effect of the flooding phenomenon in the dripping zone below and the hanging phenomenon in the burden above, denser species can be reduced and/or less dense species can be added. Although as mentioned above, it is explicitly foreseen within the present context to use e.g. hydrogen, helium or both to act on the density of the first reducing gas. It is highly desirable to use a reducing gas having a certain proportion of hydrogen as this gas has a much lower density and a much lower (dynamic) viscosity than any other gas, while further being useful as reducing agent. Indeed, the inventors conceived that decreasing the density of the first reducing gas leads to a desirably lower pressure drop along the whole smelting/blast furnace, but especially through the cohesive and dripping zones. An increased proportion of hydrogen further reduces the (dynamic) viscosity of the reducing gas, which again favors a better flow and distribution of the first reducing gas, especially through both the cohesive zone and the dripping zones. Therefore, advantageously, the first reducing gas may be a hydrogen-enriched gas, such as a hydrogen-enriched syngas or gas resulting from ammonia cracking and/or methanol cracking and/or ethanol cracking. The first reducing gas may have a hydrogen content above about 30 vol.-%, preferably above about 35 vol.-%, above about 40 vol.-%, above about 50 vol.-%. Values above about 60 vol.-%, above about 65 vol.-%, above about 70 vol.-%, above about 75 vol.-%, above about 80 vol.-%, above about 85 vol.-%, above about 90 vol.-%, above about 95 vol.-% and even above about 98 vol. % are also possible.

The first reducing gas may therefore be any appropriate reducing gas having the density given above. In particular, the first reducing gas may comprise or consists of a syngas, such as those obtained from known reforming processes. It is particularly preferred that it has a molar ratio (H₂+CO)/(H₂O+CO₂) above about 7, preferably above about 8 and more preferably above about 9. This molar ratio can even be higher, such as above about 12 or even above about 15. Alternatively, or additionally, the first reducing gas could comprise or consists of a gas resulting from cracking of ammonia (N₂+3H₂) and/or cracking of methanol and/or cracking of ethanol. In any case, these reducing gases can be enriched with hydrogen as indicated above if necessary or desired.

It is particularly preferred to provide the energy required for heating, melting, as well as for the proper progression of the iron oxide reduction, or at least to provide a significant part of it, with the first reducing gas. The required heating depends of course on the initial temperature of the first reducing gas before actually being heated to the required temperatures. Depending on the prior steps, such as the type of reforming, the first reducing gas generally has an initial temperature from 800 to 1500 °C, such as from 900 to 1300 °C. As it is preferred to inject the first reducing gas at a temperature from about 1600 °C to about 2600 °C, more preferably at a temperature above about 1800 °C or about 1900 °C and most preferably above about 2000 °C, such as above about 2150 °C, about 2300 °C, about 2425 °C or even above about 2500 °C, the residual heating is provided by one or more appropriate heaters as further described below. In particularly advantageous embodiments of the present method, the actual temperature of the first reducing gas is controlled based on a number of operational parameters of the smelting furnace installation, such as e.g. the temperature, pressure, mass/volume flow rate and composition of the top gas, the particular charging parameters of the smelting furnace, such as temperature and flow rate of coke, iron oxide containing material and/or fluxing agents, measured values indicative of the current operating conditions at different locations within the smelting furnace, such as temperature, pressure, the composition and temperature of the product and of course the production rate, etc. In particular the temperature of the first reducing gas can also be controlled (among others) as a function of the temperature of the second reducing gas or vice-versa, as will be further described below.

In embodiments, the smelting furnace installation may further comprise at least one sensor adapted to analyze the composition of the gas at the top of the smelting furnace with regard to the CO, CO₂ and/or H₂ concentration of the gas, optionally also adapted to analyze the composition of the gas with regard to the H₂O, N₂, and/or CH₄ concentration in the gas. The sensor can be inside the furnace within the top level or can be connected to a piping which retrieves gas from the top level of the furnace.

The sensor can be any kind of sensor adapted to determine a gas composition, such as e.g. of electrochemical, catalytic bead (pellistor), photoionization, infrared point, infrared imaging, semiconductor, or ultrasonic type. The sensor of the semiconductor type can be a metal-oxide-semiconductor sensor. The sensor can be comprised in a gas chromatograph.

To impart the required energy and thus the desired temperature to the first reducing gas, any known process or combination of known processes may be used, possibly depending on the initial temperature of said reducing gas. The first reducing gas is preferably heated with one or more electric heaters before injection to the smelting furnace. As the envisaged temperatures are rather high, it may be useful or desirable, especially when temperatures over about 1800 °C are to be reached, to impart additional heat as late as possible before the actual injection takes place, such as by providing at least part of the heating downstream the bustle pipe, e.g. within the tuyere stock(s), such as after the down-leg, preferably within the blowpipe(s), or even within the tuyere itself, most preferably by one or more plasma torches located at any appropriate position within the blowpipe(s) or the tuyere(s). Nevertheless, placing (additional) heaters, such as resistive or plasma electric heaters upstream the tuyere stock(s), e.g. in the bustle pipe or even upstream of the bustle pipe (downstream the reforming) is also possible and hereby explicitly contemplated in the context of the present disclosure. In preferred embodiments, the first reducing gas may be heated by electric heaters (i.e. electrically driven heaters), each one of the electric heaters being adapted to operate at an electric power of 200-700 kWh/t HM, 250-600 kWh/t HM, or 300-550 kWh/t HM.

In cases where the first reducing gas is (at least partially) heated with one or more plasma torches arranged e.g. within a blowpipe of the tuyere stock(s), the plasma torches are preferably electrode-based plasma torches or electrodeless plasma torches, such as selected from inductively ignited plasma torches, microwave plasma torches, radiofrequency plasma torches or combinations thereof. Appropriate plasma torches are direct current plasma torches or alternating current plasma torches, such as e.g. 3-phase alternating current plasma torches, wherein said plasma torches generally have an electric power rating of 1 to 10 MW, preferably of 2 to 6 MW, most preferably of 4 to 5 MW. Further details about suitable plasma torches and suitable locations within the smelting furnace installation will be provided below.

Contrary to the first reducing gas, the second reducing gas will generally not be injected at such high temperatures, although similar temperatures may be used if deemed desirable or necessary. In fact, in most cases, the second reducing gas is preferably injected at temperatures from about 800 °C to about 1200 °C, more preferably at a temperature from about 900 °C to about 1100 °C and most preferably below about 1000 °C, such as below about 950 °C. As already briefly mentioned in the context of the temperature of the first reducing gas, the actual temperature of the second reducing gas is preferably controlled based on one or more of a number of operational parameters of the smelting furnace installation, such as e.g. the coke reactivity temperature, pressure, mass/volume flow rate and composition of the top gas, the particular charging parameters of the smelting furnace, such as temperature and flow rate of coke, iron oxide containing material and/or fluxing agents, measured values indicative of the current operating conditions at different locations within the smelting furnace, such as temperature, pressure, gas composition, etc. In particular, the temperature of the second reducing gas can also be controlled (among others) as a function of the temperature of the first reducing gas or vice-versa.

The smelting furnace installation may further comprise a gas injector regulating device configured to adapt the composition of the gas and/or the volume of the gas injected by the first and/or second injector arrangement based on the determined gas composition and/or temperature at the top of the furnace.

The gas injector regulating device may also adapt the power supply to the at least one electrical heater based on the determined gas composition at the top level and/or temperature at the top level.

The gas injector regulating device may also be configured to adapt the composition of the gas and/or the volume of the gas injected and/or the temperature of the gas injected by the first and/or second injector arrangement based on the composition and/or temperature of the hot metal outputted by the smelting furnace and the hot metal production rate. To determine the composition of the hot metal outputted by the smelting furnace and the hot metal production rate, the smelting furnace installation may comprise further sensors positioned at the hot metal outlet of the furnace configured to determine the composition of the hot metal and to determine the volume of the hot metal.

In the present disclosure, the rate of lump coke fed to the smelting furnace is low compared to conventionally operated blast furnaces. However, in particular in the cohesive zone, the permeability to gases is significantly reduced also due to the fact that the molten slag penetrates into the coke layer and thereby clogs part of its height. As this reduces the permeable height of the coke layer, it is generally desirable not to feed coke in layers not having a minimum height. Such a minimum height is generally at least about 8 cm, such as at least about 10 cm, such as e.g. between 9 and 11 cm, at least about 12 cm, or at least about 15 cm, such as e.g. 14 to 15 cm.

In still further embodiments, the method disclosed herein further comprises in particular the step of adjusting the average degree of reduction of the iron oxide containing material reaching the cohesive zone to a value of above about 80%, more preferably above about 85% by controlling the amount (injection rate) and/or the composition of the second reducing gas injected at the shaft level as a function of the amount (injection rate) and/or composition of the first reducing gas injected at tuyere level and/or the amount (injection rate) of oxygen injected (if any) at tuyere level.

As already mentioned, the lump coke rate required depends among others on the amount of coke consumed by the direct reduction of iron ore. In embodiments, the lump coke rate can thus be decreased by controlling the lump coke consumption for direct reduction, which in turn can be controlled by adjusting the amount (injection rate) and/or the composition of the second reducing gas injected at the shaft level as a function of the amount (injection rate) and/or composition of the first reducing gas injected at tuyere level and/or the amount (injection rate) of oxygen injected (if any) at tuyere level. Hence, the lump coke rate may be (further) decreased, such as to values below 220 kg/t HM, by controlling the coke consumption for direct reduction below about 60 kg/t HM, preferably below about 50 kg/t HM, more preferably below about 40 kg/t HM.

Alternatively, or additionally, the present method preferably further comprises the step of reducing/limiting the channeling effect/phenomenon above the cohesive zone by controlling the (flow rate, speed and pressure of) injection of the second reducing gas in (a lower part of) the shaft of the smelting furnace. This advantageous effect is obtained because the second reducing gas is injected at shaft level, preferably along the circumference of the smelting furnace, such that the gas ascending from the cohesive zone is centered within the smelting furnace. It is therefore advisable that the first reducing gas injectors (i.e. tuyeres) and/or second reducing gas injectors are evenly distributed, generally at distances between 0.5 and 2.5 m, and preferably between 1.0 and 1.5 m between each other. Furthermore, the injection speed of the second reducing gas at shaft level may advantageously be controlled to values between 40 and 250 m/s, such as preferably between 80 and 200 m/s. It is also generally helpful or desirable to control the ratio between volume flow of the second reducing gas (injected at shaft level) and the volume flow of the first reducing gas (injected at tuyere level) to values from 0.1:1, to 1:1, preferably from 0.2:1 to 0.8:1, more preferably from 0.33:1 to 0.7 to 1, or even from 0.4:1 to 0.7:1, 0.65:1 or 0.6:1.

As already stated above, the second reducing gas useable in the present method usually comprises syngas. It may also consist of only syngas, meaning that the second reducing gas has the composition as is, e.g. as obtained from a reforming process, preferably from a reforming process as mentioned previously. Independently of the source or preliminary treatments of the second reducing gas, it is particularly preferred that it has a molar ratio (H₂+CO)/(H₂O+CO₂) above about 6, preferably above about 7 and more preferably above about 8. This molar ratio can even be higher such as above about 12 or even above about 15. In embodiments, this molar ratio may be below about 80, or below about 30.

The second reducing gas may be enriched with hydrogen, such as a hydrogen-enriched syngas. Independently of its original composition, it advantageously has a (final) hydrogen content above about 30 vol.-%, preferably above about 40 vol.-%, more preferably above about 50 vol.-%.

It is further preferred that the first reducing gas and/or the second reducing gas, preferably both, contain essentially no nitrogen, if any. Hence, the first reducing gas and the second reducing gas preferably (independently) have nitrogen contents below about 35 vol.-%, more preferably below about 15 vol.-%, still more preferably below about 10 vol.-% and most preferably below about 5 vol. %.

The method of the present disclosure preferably also comprises an active control of the pressure level of any gas injected at the tuyeres. Advantageously, the pressure level of the smelting furnace at the tuyere level is controlled to values above about 2 barg, preferably above about 4 barg and more preferably above about 5 barg. Indeed, a higher pressure level also has a positive impact on the flooding phenomena, i.e. the pressure exercised on the liquid droplets. The higher the pressure, the higher the density, but also the lower the velocity of the gas. Since the effect of the gas on the liquid droplet is depending stronger on the velocity (power 2) then on the density, an increase in pressure will help to further improve the situation in the cohesive and dripping zones.

In advantageous embodiments, the method further comprises the step of reducing the channeling effect and flooding effect by controlling the top pressure of the smelting furnace in the range of 1 to 10 barg, more preferably in the range of 2 to 7 barg and most preferably between 3 and 5 barg.

Alternatively, or additionally, the method may further comprise the step of reducing the wall channeling effect of the gas coming from the cohesive zone to the furnace wall in the lower shaft zone by controlling the injection conditions of the second reducing gas, such as specifically the injection speed and/or rate of the second reducing gas injected in the shaft of the smelting furnace.

In the present method, it may be advantageous to include a further step of reducing the carbon dioxide content of any one or more carbon dioxide containing offgas and/or process gas produced during operation by carbon capture and utilization (CCU) and/or carbon capture and storage (CCS).

In this context, it is specifically interesting to use at least part of the captured CO₂ in so-called syngas production plants, for example by converting the carbon dioxide together with CO₂ lean hydrogen to a syngas and further to a synthetic hydrocarbon such as natural gas by methanation and/or to produce methane, methanol, ethanol, etc. by any other appropriate production processes, including biologic ones, etc. All or part of the methane, methanol, ethanol, etc. can then be used for the syngas production which can be injected in the blast furnace.

As already mentioned above, in the present method it may be advantageous to also incorporate ammonia (NH₃) and/or cracked ammonia (N₂+3H₂) as hydrogen rich fuel within the limits of the acceptable nitrogen concentration of the syngas, both for use as (or in) the first and/or second reducing gas(es). In fact, this would be of particular interest if ammonia will become commercially available as a CO₂ free energy carrier with high hydrogen content.

The expressions “at shaft level” or “injecting . . . at a/the shaft level of the smelting furnace” imply that the injection is made in the lower shaft zone above the level of the hot blast/tuyere level, in particular above the bosh, preferably within the gas solid reduction zone of ferrous oxide above the cohesive zone. Preferably, the injection at shaft level can thus be made (e.g. immediately) above the root of the cohesive zone, the region of the cohesive zone directly contacting the wall of furnace (i.e. above the root of the cohesive zone). In other words, the equivalent expressions “shaft level” or “lower shaft level” refer to a level allowing for the injected gas to participate in the reduction reaction, preferably to a level in the FeO reduction zone. Conversely, the expressions “at tuyere level” or “injecting . . . at a/the tuyere level of the smelting furnace” imply that the injection is made at the level conventionally provided with the tuyeres for hot blast, preferably using the conventional tuyeres in the lower part of the bosh, i.e. well below the cohesive zone.

An “injector arrangement” is to be understood in the present context as comprising one or more injectors, optionally including any corresponding associated upstream connection conducts, piping and regulation and control components, reducing gas treatment/heating/cooling, etc. Depending on the particular context, the first injector arrangement located at tuyere level may thus refer to one or more tuyeres as such or said tuyere(s) with any one or more associated upstream parts, such as the blowpipe assembly/ies or tuyere stock(s), the bustle pipe, first reducing gas treatment or heating units, connecting piping and control components, etc. Similarly, depending on the particular context, the second injector arrangement located at shaft level may refer to one or more shaft injectors as such or said shaft injector(s) with any one or more associated upstream parts, such as the injector feeding assembly/ies, the shaft ring pipe, second reducing gas treatment or heating units, connecting piping and control components, etc.

In embodiments, the first injector arrangement may comprise at least 10 first gas injectors (i.e. tuyeres), and up to 70 first gas injectors (i.e. tuyeres), preferably between 18 and 40 first gas injectors. According to the same or other embodiments, the second injector arrangement may comprise at least 10 second gas injectors, and up to 70 second gas injectors, preferably between 18 and 40 second gas injectors.

The expression “equivalent coke rate” includes all carbonaceous gaseous, solid or liquid (at ambient temperature) materials fed to the smelting furnace, including the actual coke material (fed at a lump coke rate), but also further carbonaceous gaseous, solid or liquid materials that could be added to the operating smelting furnace, such as e.g. gaseous methane, natural gas and/or pulverized coal injected at tuyere level. Pulverized coal or further carbonaceous gaseous, solid or liquid materials may be injected at the tuyere level if desirable or deemed helpful, e.g. to provide the required energy by being combusted inside the furnace when the first reducing gas is (temporarily, e.g. due to shortage of heating means) injected at a temperature lower than 1600 °C and/or upon restart after maintenance stoppage. However, the injection rate of further carbonaceous material is preferably below 150 kg/t HM, more preferably below 120 kg/t HM. Most preferably however, the present method does not feed such further gaseous, solid or liquid carbonaceous material to the smelting/blast furnace, in particular the present method does not contemplate or comprise the injection of pulverized coal to the smelting/blast furnace, but only the feeding of coke as carbonaceous solid material to the top of the smelting/blast furnace. Therefore, the expression “lump coke rate” as used herein indicates the rate of coke material actually added to the top of the blast furnace. In fact, “lump coke” refers to the coke charged into the furnace, generally with sizes greater than 20 mm. In preferred embodiments, the furnace is operated with a (total) equivalent coke rate of below 220 kg/t HM, preferably below 200 kg/t HM and more preferably below 180 kg/t HM.

Rates expressed as “/t HM” refers to per tonne (metric ton) of hot metal produced by the blast furnace installation. “Nm³” refers to normal cubic meter to indicate a volume of 1 cubic meter of gas at normal conditions, i.e. at a temperature of 0 °C (273.15 K) and an absolute pressure of 1 atm (101.325 kPa).

In the present context, the expression “hydrogen-enriched” or “enriched with hydrogen” relative to a gas (mixture) means that hydrogen gas (H₂) is actively and deliberately added to said gas (mixture) to raise the molar proportion of hydrogen within the resulting hydrogen-enriched gas (mixture).

In the present context, the rate of oxygen injection at the tuyere level refers to the total amount of oxygen injected.

A “reducing gas” in the present context means a gas able to participate in, i.e. perform, a reduction reaction, that is to say a gas comprising reducing species such as H₂ and/or CO, preferably wherein H₂ represents 30-100 vol.-%, CO represents 10-70 vol.-% and compounds other than CO and H₂ represent less than 35 vol.-%, more preferably less than 10 or even less than 5 vol.-% of the reducing gas. In embodiments, the reducing gas has a hydrocarbon concentration below 25 vol.-%, preferably below 20 vol.-% and more preferably below 10 vol.-%.

“About” in the present context, means that a given numeric value covers a range of values from −10% to +10% of said numeric value, preferably a range of values from −5% to +5% of said numeric value or even a range of values from −2.5% to +2.5% of said numeric value.

The method of the present disclosure and the further variants disclosed herein have a number of important advantages and benefits:
low CO₂ emissions,
no, or limited change in steel plant layout and logistics, the method can be implemented on existing blast furnaces with limited modifications,
due to shaft injection, the tuyere gas amount can be decreased by about 15 to 30%, thereby allowing for a rough 25 to 50% decrease in lump coke layer thickness,
due to H₂ within the first reducing gas, the dynamic viscosity of this gas can be decreased by about 15%, thus allowing for a higher speed with same pressure drop and same force on coke particles and droplets,
due to H₂ within the first reducing gas, the density of this gas can be decreased by about 50%, thus allowing for a higher speed with same pressure drop and same force on coke particles and droplets,
no or almost no coke burning in the smelting furnace, thus no or almost no oxygen requirement,
usually no pulverized coal or auxiliary fuel injection required for reaching very low coke consumption, and
easy restart because the syngas is produced outside the furnace, such as by steam reforming or H₂ injection during ramp-up.

### BRIEF DESCRIPTION OF THE DRAWINGS

Preferred embodiments of the disclosure will now be described, by way of example, with reference to the accompanying drawings in which:

FIG. 1 is a schematic view of an advantageous embodiment of the present disclosure.

FIG. 2 is a schematic partially cut-out view of an advantageous embodiment of (part of) a first injector arrangement useful in the present disclosure.

FIG. 3 illustrates the zones within a blast furnace and effect of lower shaft injection of reducing gas B on the rising gas passing through the coke layers within the cohesive zone.

Further details and advantages of the present disclosure will be apparent from the following detailed description.

### DETAILED DESCRIPTION OF THE DRAWINGS

### General Considerations

The main issue of the blast furnace with regard to CO₂ emissions is that its process is based on the reduction of iron ore based on coke and also on the injection of carbon rich auxiliary fuel/reductant at tuyere level.

The injection of a syngas at shaft or even at tuyere level has been proposed to help to decrease the coke consumption in the blast furnace and therefore to reduce the CO₂ emissions. Nevertheless, even under these conditions, there is still a requirement for a non-negligible lump coke rate, generally still above 300 kg/t HM. This requirement of a still substantial coke rate comes mainly from process and to a minor extend from mechanical/fluid dynamic reasons.

Today, the blast furnace seems more and more overtaken by alternative process routes which need only small amounts of coke. In fact, these processes divide the blast furnace in two: an iron ore reduction part, performed in a shaft furnace, and a melting part, done in an electric melting furnace, the latter using a kind of electric arc/plasma or immersed electrodes. This concept however results in very big and complex installations which are very costly CAPEX-wise and also difficult to maintain. Also, the melting furnace still requires a significant amount of coke, about 60 to 110 kg/t HM in case of utilization of hydrogen-reduced direct reduced iron (DRI). This carbon is required to finalize the reduction of the DRI and to carburize the hot metal that will then be processed in a basic oxygen furnace.

The present method aims at being able to show that the widely used blast furnace technology, if converted appropriately as described herein, is able to provide solutions with low CO₂ emissions and thereby allowing to use the (modified) blast furnace with a very low coke rate by improving the process conditions in the blast furnace.

In fact, the conventional blast furnace today uses coke for different requirements:
Indirect reduction of the iron ore in the shaft:

3Fe₂O₃+CO→2Fe₃O₄+CO₂ and Fe₃O₄+CO→3 FeO+CO₂
Direct reduction of the iron oxide in the lower part of the blast furnace, reducing the molten iron oxide directly as: FeO+C→Fe+CO
Solution loss: at a certain level of temperature the coke reacts with carbon dioxide and H₂O to generate carbon monoxide and H₂:

C+CO₂↔2CO

C+H₂O↔CO+H₂
Carburization of the molten iron. The iron saturated with carbon at typical operating temperatures of the blast furnace at around 1500 °C has about 4.5% dissolved carbon. This is also the prerequisite for the blast furnace, since it allows the hot metal to be liquid at this temperature level.
Burning of coke at the tuyere to generate the hot reducing gas required to melt and to reduce the iron ore. The hot reducing gas should reach the minimum flame temperature required for the operation of the blast furnace (1800-2600 °C). In fact, the flame temperature assures the heat transfer from the gas phase to the ore and its subsequent melting. If that temperature is too low, the blast furnace cannot achieve a high production.
Due to chemical equilibria, approximately half of the reducing gas generated in the blast furnace is exiting at the top (top gas) without reacting. The remaining calorific value of the top gas is generally used to ⅓ for heating the hot blast and ⅔ are exported out of the blast furnace plant.

In a standard blast furnace application today, with a coke rate of 310 kg/t HM and 180 kg/t HM of injected pulverized coal (PCI), the coke consumption for the different factors is distributes as follows, see Table 1.

TABLE 1

| In kg/t HM | Case 0 |
|---|---|
| PCI gasified/burned at tuyere | 180 |
| Coke gasified/burned at tuyere | 120 |
| Coke solution loss shaft | 28 |
| Coke for HM solution | 47 |
| Coke for direct reduction | 114 |
| Total coke | 310 |

Note:
approx. values only

The question is now how to diminish that coke rate?

The coke dissolved in the hot metal cannot really be reduced since the coke will dissolve in the hot metal until its saturation. The saturation of hot metal by carbon ensures also a long life for the carbon blocs in the hearth. It is therefore in principle not possible to diminish these 47 kg/t HM (see Table 1).

The necessary coke for the direct reduction in the lower part of the blast furnace could be heavily reduced if the reduction degree of the ore coming from the upper part of the blast furnace is increased. Increasing the reduction degree could be done by increasing the reductant to oxidant ratio (CO+H₂)/(CO₂+H₂O) in the gas phase in the blast furnace shaft. This can be done by increasing the reducing gas flow, for example by injecting reducing gas at the bottom of the shaft. Another option would be by increasing the accumulated concentration of H₂+CO mainly by decreasing the N₂ content in the injected gas at tuyere level and at shaft level.

The necessary coke for the solution loss can be reduced as well by increasing the reductants to oxidants ratio in the gas passing through the shaft of the blast furnace. This can be done by increasing the reducing gas flow, for example by injecting reducing gas at the bottom of the shaft. Again, it could also be done by increasing the accumulated concentration of H₂+CO such as by decreasing the N₂ content in the injected gas at tuyere level and at shaft level.

The necessary energy for the lower part of the blast furnace is generated at the tuyere level where coke and auxiliary fuel like PCI or natural gas are burned and gasified with hot blast (between 900 and 1300 °C) and produce the tuyere gas at temperature of between 1800 and 2500 °C. A high amount of fuel needs to be burned for that purpose since it oxidizes only to CO and not to CO₂. This results in a much lower release of reaction heat, thus a much lower flame temperature as when burning the fuel completely to CO₂ and H₂O as it can be done in an oxidizing atmosphere.

What the present disclosure proposes to do:

In the present disclosure, it is proposed to combine both types of injection, the utilization of a reducing gas in the blast furnace injected both at the bottom of the shaft and at the tuyere level, in which the reducing gas injected at the tuyere level is further heated up to a temperature similar or as close as possible to the usual blast furnace flame temperature. Thus, the present disclosure considers heating the tuyere reducing gas, e.g. syngas, to at least 1600 °C, preferably above 1800 °C, more preferably above 2000 °C and possibly even over 2300 °C.

When injecting the hot reducing gas at shaft and tuyere level, the present method completely avoids a priori the requirement of oxygen containing hot blast. However, it is still possible to maintain a small amount of injected cold oxygen, such as below 120 Nm³/t HM, preferably below 112 Nm³/t HM, together or not with some auxiliary fuel as natural gas, coke oven gas, pulverized coal, etc., at the tuyere if desirable or deemed helpful. Usually, minimum injection rates for oxygen at tuyere level are above about 4 Nm³/t HM, such as above about 12 Nm³/t HM, above about 25 Nm³/t HM, e.g. above about 35 Nm³/t HM, or even above about 50 Nm³/t HM.

For heating the (first) reducing gas, different methods can be used to efficiently heat the reducing gas, e.g. from syngas production temperature (about 950 °C in case of catalytic reforming processes and partial oxidation/autothermal reforming, around 1200 °C in case of non-catalytic reforming processes, preheated or non-preheated temperature in case of (V) PSA (0 to 1300 °C) to the desired/required temperature. Technologies useful to that end are known. Advantageously, electric energy can be used for that purpose, especially “green” or renewable electric energy, e.g. through resistance heating and/or plasma technology.

Furthermore, the reducing gas can be produced with any appropriate method, such as in a CO₂ removal plant, e.g. an amine type adsorber, PSA or VPSA starting from blast furnace gas, basic oxygen furnace gas or others in which the CO₂ separation might be increased by using sorption enhanced water gas shift reactor. The reducing gas could also be the hydrogen-rich stream of a hydrogen removal plant.

Furthermore, it also explicitly foreseen to use pure hydrogen gas as a reducing gas or a mixture of N₂ and H₂ resulting from the cracking of ammonia (or even the cracking of methanol and/or ethanol) as mentioned above.

In a method as disclosed herein, it is in principle possible to reach coke rates of about 100 kg/t HM by almost completely eliminating the nitrogen in the gas passing through the blast furnace and by injecting the gas in the blast furnace at about the flame temperature.

Alternatively to the heating of the syngas injected at the tuyere, it is also possible to supply the electric power directly to the blast furnace, for example, by using a plasma torch, electrodes directly immerged in the blast furnace, by inductive heating, etc.

It is of particular benefit to reprocess part of the blast furnace top gas in a reformer, PSA, VPSA, CO₂-removal plant, etc. for producing a reducing gas having an adequate reductant to oxidant ratio. The present method considers various processes for producing reducing gas and injecting it, also together with hydrogen, and/or cracked ammonia in the blast furnace at shaft and also tuyere level.

It is also considered to use part of the blast furnace top gas as heating fuel for the syngas production. Only a very small part of the blast furnace top gas could leave the blast furnace plant, which is an indication of high efficiency.

For permeability reasons, coke rates below 90 kg/t HM might not be reachable, but the present method allows reaching coke rates significantly below 200 kg/t HM.

As explained above, the permeability issue is the main reason why part of the reducing gas is not injected at tuyere level, but rather at the bottom of the shaft of the furnace. Indeed, decreasing the coke rate to minimum levels will decrease the passing area for the ascending gas in the cohesive zone. This raises the gas velocity and pressure drop in the cohesive zone and the upper dripping zone and which might also lead to abnormality in the distribution of gas radially and circumferentially. It is therefore very important to reduce the gas volume in the tuyere and bosh area, which is achieved by partially injecting the reducing gas at shaft level. It is also advantageous to decrease the density and viscosity of the reducing gas. This can be reached by the use of the hydrogen rich reducing gas, additionally enriched or not with hydrogen, which has a very low density and viscosity, which in turn results in less pressure drop and lower gas velocity.

The present method will still use some coke and may require e.g. methane for reforming of the recycled top gas. Additional CO₂ savings can be achieved when producing the natural gas with help of the methanation of CO and/or CO₂ containing gases such as the top gas of the blast furnace and/or the gas of the basic oxygen furnace. As an alternative to natural gas, methane produced by methanation can also be employed to further reduce the CO₂ footprint.

Finally, the present method may also comprise the capture of the CO₂ from waste gas of the reformers/heaters or any other steel plant process gases for usage or storage to further reduce the overall CO₂ footprint.

### Case Study: Reducing Gas Utilization in a Blast Furnace

To better illustrate the disclosure, several cases have been investigated in more depth. The details of the cases are presented in Table 2 below.

Case 1 and 2 are the blast furnaces running today with coarse coke rate of 255 kg/t HM and 205 kg/t HM respectively.

Case 3 and 4 are dedicated for the blast furnace with hot H₂ injected to tuyere without and with hot hydrogen injection to the shaft respectively.

Cases 5 and 6 are about the new furnaces with about 180 kg/t HM and about 110 kg/t HM using a superheated syngas injection at tuyere level.

Cases 7 and 8 are about the new furnaces with about 180 kg/t HM and about 100 kg/t HM using a superheated syngas injection at tuyere level, and addition to that, an injection of a hot syngas into the shaft.

Case 1 represents a typical well operated blast furnace with high pulverized coal injection (PCI) as one can find several all over the world and specifically in Europe. The pulverized coal injection allows to decrease the lump or coarse coke rate to values of about 250 kg/t HM.

As can be seen, this furnace requires about 235 Nm³ of oxygen per metric t of produced hot metal (t HM). Part of this oxygen comes with the heated air, part of it comes from oxygen enrichment with pure oxygen coming from an air separation plant.

This oxygen enrichment is required since the blast furnace requires a certain flame temperature in order to operate correctly. In fact, the flame temperature assures that the reduced ore can be molten and that the injected coal can be burnt within the raceway. With high PCI, the required flame temperature is about 2200 °C.

In this case, it is not possible to eliminate the natural blast completely, since a certain gas volume is needed in order to have enough latent heat required to supply the energy for the heating and reduction of the ore in the shaft of the furnace.

Case 2 represents a typical blast furnace reaching exceptionally high PCI injection. Such operations have already been sustained for long production periods of several months. This operation is however quite challenging and requires high operational skills and very good raw materials, in particular, high quality of costly cokes. In this case it is important to note that a coarse coke rate of 205 kg/t HM has already been reached.

If one compares the injection conditions at the tuyere, one can see that the oxygen enrichment had to be further increased, but altogether the conditions at the tuyere, hot blast temperature, gas volume flow rate, have not drastically changed.

Both these operations are of course not desirable if one wants to reduce the CO₂ emissions from the hot metal production since the complete energy and reductant input is based on coal.

Cases 3 and 4: In these cases, the inventors have analyzed the operation of a blast furnace using high hydrogen injection rates in order to reduce part of the energy and reductant input from coal and use CO₂ free hydrogen instead.

It is known that hydrogen cannot be injected in big quantities if injected cold at the tuyere together with oxygen enriched hot blast. The typical maximum amount of hydrogen utilization is restricted to below 30 kg/t HM.

Thus, the addition of hydrogen will require a change. It needs to be injected hot, only at tuyere level or at both tuyere and shaft level.

As injection temperature the inventors have assumed 950 °C at shaft level and 1200 °C at tuyere level. These are the temperature levels one can typically reach when using traditional heat exchangers and regenerative type heaters.

At tuyere level cold oxygen now needs to be added in order to burn some coke for reaching the required flame temperature for the melting of the ore. From furnaces which are not using PCI injection, it is known that in this case the flame temperature can be reduced to a minimum of about 1800 °C, always requiring a sufficient flow rate to supply enough energy for melting the reduced ore and supply the energy for the heating and reduction of the ore in the shaft of the blast furnace.

As can be seen, it is possible to reduce the oxygen injection at the tuyere from about 240 to 150 and 180 Nm³/t HM, respectively. Less carbon will thus need to be burned at the tuyere. However, since there is no carbon available from PCI injection, the coke that needs to be burned at the tuyere is higher as in the Cases 1 and 2, leading to an increased coke rate.

This contradiction of additional coal/coke requirement when using hydrogen in a blast furnace, thus required CO₂ emission reduction, cannot be overcome with conventional methods.

Additionally, it can be seen that pure H₂ injection would in both cases, with and without shaft injection, require huge amounts of hydrogen, 1070 and 1280 Nm³ of hydrogen per t of hot metal with and without shaft injection respectively. This is by far exceeding the hydrogen requirement of other production routes such as the direct reduction process requiring about 660 Nm³/t HM hydrogen. Moreover, the required coke rate in these cases is quite high, making them uninteresting.

To overcome this problem the inventors are proposing the injection of a syngas with or without pure hydrogen addition, at superheated temperatures to the blast furnace.

The superheating can be done by plasma torches for example.

Cases 5 and 6: In these cases, superheating the gas that is injected at tuyere level has the advantage that we now do not need to burn coke with oxygen to have the temperature level at the tuyere required for melting of the reduced ore.

Cases 7 and 8: These cases have additional syngas injection into the shaft compared with the Cases 5 and 6. The inventors propose to operate the furnace by partly injecting the gas in the shaft of the furnace to be able to supply the required temperature level for melting with a lower electric energy requirement of the plasma torch. Moreover, with the shaft injection, less gas needs to pass through the high-resistance cohesive zone area.

Contrary to Cases 7 and 8, in Cases 5 and 6 all the reducing gas required for operating needs to go through the tuyeres and thus through the dripping zone and the cohesive zone, which will lead to the problems of flooding and hanging, respectively. Furthermore, in Cases 5 and 6, there is no way to avoid the wall channeling phenomenon described above.

By operating a blast furnace as described herein, it is now possible to actually reach the very low coke rates presented in Cases 7 and 8, i.e. of about 180 and about 100 kg/t HM, respectively.

It can also be seen, that the use of pure hydrogen is also very low in case of 100 kg/t HM with 440 Nm³/t HM.

This can be reached e.g. by recycling the top gas of the blast furnace back to the blast furnace. For this the content of H₂O and CO₂ needs to be reduced. The H₂O can easily be reduced by cooling and condensation. The CO₂ elimination is somehow more complicated and different methods have been proposed such as PSA, VPSA and also reforming of CO₂ with hydrocarbons to form CO and H₂.

In the example, a reforming with natural gas has been used.

Such a reforming can be done catalytically at temperatures of about 950 °C or without catalyst in a regenerative reformer type at elevated temperatures >1100 °C. Since specifically at the tuyere level very high temperatures are desirable, the latter type is very well suited for preparing the gas at the tuyere level.

Also when reforming the gas at high temperatures, it is possible to reach a very high reduction degree of the gas (CO+H₂)/(CO₂+H₂O)>7, preferably >8, more preferably >9. High reduction degrees are very important to reach a low coke rate since every CO₂ and H₂O in the gas will consume coke in the raceway.

TABLE 2

| | Case1 | Case2 | Case 3 | Case 4 | Case 5 | Case 6 | Case 7 | Case 8 |
|---|---|---|---|---|---|---|---|---|
| | BF1 | BF2 | BF with | BF with | New | New | New | New |
| | | | hot H2 | hot H2 | furnace | furnace | furnace | furnace |
| | | | injected | injected | with 180 | with 110 | with 180 | with 100 |
| | | | to | to | kg/t HM, | kg/t HM, | kg/t HM, | kg/t HM, |
| | | | tuyere | tuyere | without | without | with | with |
| | | | | and | shaft | shaft | shaft | shaft |
| | | | | shaft | injection | injection | injection | injection |
| Total coke rate (kg/t | 301 | 256 | 274 | 324 | 180 | 114 | 177 | 102 |
| HM) | | | | | | | | |
| Lump coke rate (kg/t | 255 | 205 | 274 | 324 | 180 | 114 | 177 | 102 |
| HM) | | | | | | | | |
| Nut coke rate (kg/t | 46 | 51 | 0 | 0 | 0 | 0 | 0 | 0 |
| HM) | | | | | | | | |
| PCI (kg/t HM) | 192 | 232 | 0 | 0 | 0 | 0 | 0 | 0 |
| Cold O₂ (Nm³/t HM) | 63 | 89 | 148 | 183 | 71 | 1.9 | 75 | 6 |
| Natural dry blast | 821 | 740 | 0 | 0 | 0 | 0 | 0 | 0 |
| volume (Nm³/t HM) | | | | | | | | |
| Total O₂ (Nm³/t HM) | 235 | 244 | 148 | 183 | 71 | 1.9 | 75 | 6 |
| Flame temperature | 2 230 | 2 175 | 1 796 | 2 225 | 1 876 | 1 848 | 2 032 | 1 997 |
| (°C) | | | | | | | | |
| Top gas volume, dry | 1392 | 1337 | 1285 | 1209 | 1005 | 1011 | 1084 | 1205 |
| (Nm³/t HM) | | | | | | | | |
| LHV of top gas, | 3574 | 3673 | 9781 | 9496 | 7809 | 8 914 | 7 846 | 9 065 |
| kJ/Nm³ | | | | | | | | |
| Reducing gas | 0 | 0 | 0 | 310 | 0 | 0 | 300 | 565 |
| injected to the shaft, | | | | | | | | |
| (Nm³/t HM) | | | | | | | | |
| Reducing gas | 0 | 0 | 1280 | 760 | 947 | 1200 | 760 | 889 |
| injected to tuyere | | | | | | | | |
| (Nm³/t HM) | | | | | | | | |
| Temperature of hot | 1250 | 1150 | 1200 | 1200 | 1750 | 2020 | 1820 | 2150 |
| reducing gas or | | | | | | | | |
| natural hot blast | | | | | | | | |
| injected to tuyere, | | | | | | | | |
| (°C) | | | | | | | | |
| Electricity | 0 | 0 | 0 | 0 | 273 | 516 | 242 | 435 |
| consumption for | | | | | | | | |
| plasma, kWh/t HM | | | | | | | | |

The volume flow rate of these gases is summarized in the following Table 3:

| | Case1 | Case2 | Case 3 | Case 4 | Case 5 | Case 6 | Case 7 | Case 8 |
|---|---|---|---|---|---|---|---|---|
| | BF1 | BF2 | BF with | BF with | New | New | New | New |
| | | | hot H₂ | hot H₂ | furnace | furnace | furnace | furnace |
| | | | injected | injected | with 180 | with 110 | with 180 | with 100 |
| | | | to | to | kg/t HM, | kg/t HM, | kg/t HM, | kg/t HM, |
| | | | tuyere | tuyere | without | without | with | with |
| | | | | and | shaft | shaft | shaft | shaft |
| | | | | shaft | injection | injection | injection | injection |
| Reducing gas into | 0 | 0 | 0 | 310 | 0 | 0 | 300 | 565 |
| the shaft, (Nm³/t HM) | | | | | | | | |
| H₂ used for reducing | 0 | 0 | 0 | 0 | 0 | 440 | 0 | 440 |
| gas production | | | | | | | | |
| (Nm³/t HM) | | | | | | | | |
| NG used for | 0 | 0 | 0 | 0 | 180 | 95 | 191 | 106 |
| reducing gas | | | | | | | | |
| production (Nm³/t | | | | | | | | |
| HM) | | | | | | | | |
| Hot blast injected to | 821 | 740 | 0 | 0 | 0 | 0 | 0 | 0 |
| tuyere (Nm³/t HM) | | | | | | | | |
| O₂ injected to | 63 | 89 | 148 | 183 | 71 | 2 | 75 | 6 |
| tuyeres (Nm³/t HM) | | | | | | | | |
| Reducing gas | 0 | 0 | 1280 | 760 | 947 | 1200 | 760 | 889 |
| injected to tuyere | | | | | | | | |
| (Nm³/t HM) | | | | | | | | |
| Gas volume at | 1 247 | 1 217 | 1 538 | 1 076 | 1 135 | 1 240 | 920 | 939 |
| tuyeres, i.e. in the | | | | | | | | |
| raceway (Nm³/t HM) | | | | | | | | |
| Gas volume in the | 1398 | 1332 | 1577 | 1147 | 1154 | 1294 | 966 | 969 |
| bosh (Nm³/t HM) | | | | | | | | |

### Coke Consumption

Coke in the BF is consumed by solution loss reaction in the shaft, carburization, direct reduction in liquid state (upper part of the dripping zone), and coke gasification/combustion in tuyere. Moreover, a little amount of coke fines is discharged into the dust during the charging of the furnace.

In Table 4 below, the amount of coke consumed by the mentioned means for all cases are presented (coke repartition).

| | Case1 | Case2 | Case 3 | Case 4 | Case 5 | Case 6 | Case 7 | Case 8 |
|---|---|---|---|---|---|---|---|---|
| | BF1 | BF2 | BF with | BF with | New | New | New | New |
| | | | hot H₂ | hot H₂ | furnace | furnace | furnace | furnace |
| | | | injected | injected | with 180 | with 110 | with 180 | with 100 |
| | | | to | to | kg/t HM, | kg/t HM, | kg/t HM, | kg/t HM, |
| | | | tuyere | tuyere | without | without | with | with |
| | | | | and | shaft | shaft | shaft | shaft |
| | | | | shaft | injection | injection | injection | injection |
| Coke burnt/gasified | 127 | 93 | 171 | 210 | 92 | 24 | 92 | 24 |
| at tuyere (kg/t HM) | | | | | | | | |
| Coke solution loss | 22 | 29 | 23 | 11 | 17 | 17 | 13 | 10 |
| shaft (kg/t HM) | | | | | | | | |
| Coke for | 51 | 55 | 51 | 51 | 51 | 51 | 51 | 51 |
| carburization (kg/t | | | | | | | | |
| HM) | | | | | | | | |
| Coke for direct | 91 | 70 | 19 | 40 | 13 | 18 | 14 | 12 |
| reduction (kg/t HM) | | | | | | | | |
| Coke in dust and | 11 | 10 | 11 | 12 | 7 | 4 | 7 | 4 |
| sludge (kg/t HM) | | | | | | | | |
| Total coke with dust | 301 | 257 | 274 | 324 | 180 | 114 | 177 | 102 |
| and sludge (kg/t | | | | | | | | |
| HM) | | | | | | | | |

It can be seen that, the coke consumption by direct reduction in liquid state is significantly lower for the new furnace condition. The reason is that ferrous burden is reduced to a very high degree in the shaft, thanks to very high reducing power (H₂+CO) in the furnace. Therefore, less FeO remains to be reduced to Fe by direct reduction and solution loss reaction. For the cases 5 to 8, coke consumption by direct reduction is below 20 kg/t HM whereas for the conventional furnace it is greater than 70 kg/t HM.

It can also be seen that in the Cases 7 and 8, the injected reducing gas into the shaft limits the coke consumption by the solution loss, consequently less chemical attack on the coke. It is therefore considered that the injection of reducing gas is not resulting in an increase in coke quality demand for the new furnace cases. Furthermore, as superheated reducing gas brings significant amount of thermal energy into the blast furnace, the need for the quantity of coke to be combusted in tuyere decreases. Nevertheless, our reducing gas contains small amount of H₂O or CO₂. These gases are converted to CO and H₂ through the reaction with carbon in the raceway area. Therefore, some coke will be consumed in this area. This can be seen by comparing Cases 7 and 8. A non-negligible part of the coke can be gasified (instead of being burnt) by the injection of the very hot reducing gas, thereby contributing to creating and maintaining the raceway even with very low rates of injected oxygen.

What has been described here shows how the coke rate can be decreased to a very low level using a superheated reducing gas injected into the tuyere and a hot reducing gas into the shaft level. Only carburization cannot be reduced by the reducing gas.

Detailed explanation to flooding and pressure drop in cohesive (melting) zone:

The objective of this description is to show the relative and not absolute change of the flooding phenomena and the pressure drop in the dripping zone as well as the entrance of cohesive zone when changing the operation of a blast furnace with higher coke rate to the operation with lower coke rate:

For the flooding the following dimensionless parameters are used:

The dimensionless parameters of the Matsu-ura and Ohno diagram, as well as their variables and units used in the calculations, are presented below as Parameters (1) and (2):

### Dimensionless Pressure Drop:

$${( \frac{Δ P}{Δ L} )}_{d} ( \frac{1}{g {ρ}_{l}} ) \qquad ( 1 )$$

ΔP, gas pressure drop between two points (Pa); ΔL, bed length measuring ΔP_{d}(m); ρₗ, liquid density (kg/m³); g, acceleration due to gravity (m/s²).

### Dimensionless Irrigation Density:

$${( \frac{{μ}^{4}}{{σρ}_{l}^{3} {g}^{5}} )}^{1 / 8} ( \frac{{u}_{l} ( 1 - ε )}{{d}_{p} ε} ) {( cos \frac{θ}{2} )}^{2} \qquad ( 2 )$$

σ, liquid surface tension (N/m); ρₗ, liquid density (kg/m³), μ, liquid viscosity (Pas); ε, void fraction (-); dp, particle harmonic diameter (m); μ, superficial liquid velocity based on empty column (m/s); θ, contact angle of liquid on solid (°).
For all variables the liquid considered was the slag. Since the slag has a much higher viscosity and a much lower density than hot metal, flooding will occur first with slag.

In the first term of Parameter (1), the dimensionless pressure drop, only the pressure drop ΔP depends on the gas characteristics.

The second term, the dimensionless irrigation density of Parameter (2) has no parameter that directly depends on the gas characteristics, but only indirectly through the coke particle voidage and the coke particle diameter.

In fact, increasing the flow rate and concentration of reducing agent (H₂ and CO) in the gas will lead to a reduced coke consumption of the coke for the indirect reduction in the shaft (through the Boudouard reaction) and the direct reduction in the dripping zone. The coke particles in the cohesive zone and more importantly in the dripping zone will thus have a bigger diameter (since being less consumed by the direct reduction reaction) in these areas. Please refer to Table 4 showing the coke repartition for different cases. The bigger diameter will also result in a higher voidage. As a consequence, the dimensionless irrigation density will therefore decrease.

It is known that at lower values for the dimensionless irrigation density the dimensionless pressure drop can be higher.

Coming back to the pressure drop and thus the

$$\frac{Δ p}{Δ L}$$

directly depending on the gas phase.

In fact, that parameter is usually calculated with help of the Ergun equation:

$$Δ p = \frac{150 μ L}{{D}_{p}^{2}} \frac{{( 1 - ε )}^{2}}{{ε}^{3}} {v}_{s} + \frac{1.75 L ρ}{{D}_{p}} \frac{( 1 - ε )}{{ε}^{3}} {v}_{s} \vert {v}_{s} \vert . \qquad ( 3 )$$

The first term of this equation is the laminar term which is in the conditions of the cohesive zone and dripping zone negligible compared to the second term, the turbulent term.

As a good approximation, it could therefore be written:

$$\frac{Δ p}{L} ∼ \frac{1.75 ρ ( 1 - ε ) {v}^{2}}{{D}_{p} {ε}^{3}} \qquad ( 4 )$$

As already discussed, the particle diameter (Dp) and the void fraction (ε) will be positively influenced by the high flux and concentrations of H₂ and CO.

One can thus further simplify, always being on the safe side, the relation to:

$$\frac{Δ p}{L} ∝ ρ {v}^{2} \qquad ( 5 )$$

The worst conditions in case of reduced coke rate will be in the entry from the dripping into the cohesive zone since the free passage of the gas is the lowest here. The velocity of gas going through the cohesive zone can be estimated as the gas volume flow rate divided by the free section in the coke layers in the cohesive zone, thus:

$$\frac{Δ p}{L} ∝ {ρ ( \frac{volume flow rate}{Free section} )}^{2} \qquad ( 6 )$$

One can with good approximation say, especially in case of unchanged coke layer thickness, that the free section is proportional to the coke rate, thus

$$\frac{Δ p}{L} ∝ {ρ ( \frac{volume flow rate}{coke rate} )}^{2} \qquad ( 7 )$$

### Embodiments of the Present Disclosure

It is known that blast furnaces have already successfully been operated with a coarse coke rate of below 210 kg/t HM using high pulverized coal injection rates, fed with highly oxygen enriched hot blast (hot air).

The oxygen consumes/burns the injected coal and coke, thus providing the energy to heat the tuyere gas to the high temperature level in the raceway required to melt the reduced ore.

In order to reduce the CO₂ emissions coming from the blast furnace we want to eliminate the injected coal and reduce as far as possible the coke rate.

For this reason, the amount of total oxygen injected to the tuyeres should be decreased to a low level, preferably below 120 Nm³/t HM, preferably below 112 Nm³/t HM.

In order to provide the energy at high temperature level to melt the reduced ore, the tuyere gas volume flow rate can only be slightly decreased, by approximately 20%, if one wants to keep the typical raceway temperatures of 1800 to 2600 °C.

Since the reducing gas is in the present process proposal no longer produced inside the raceway of the blast furnace, or at least only to a small extend, the reducing gas has to be produced outside and supply it to the furnace.

Table 4 shows that total mass flow injected to the furnace for all studied cases. It is clear that this value is significantly lower for the new furnace compared to the conventional ones, thanks to the quantity of H₂ in the gas. The composition of gas injected to tuyere for all cases is presented in Table 6.

In order not to exceed the acceptable fluid dynamic conditions in the cohesive zone we claim therefore that this can only be reached when maintaining the mass flow of the reducing gas injected at the tuyere below 800 kg/t HM, such as below 700 kg/t HM (refer to Table 5).

In order to do so, the hydrogen content of the gas injected at the tuyere level must be higher as 30%. It needs to be mentioned that although the total mass flow in case of pure H₂ (100%) is lower than our cases, the coke is as high as 274 kg/t HM and 324 kg/t HM.

TABLE 5
Total mass of gas injected to tuyere (N/A: not applicable)

| | Case1 | Case2 | Case3 | Case 4 | Case5 | Case6 | Case7 | Case8 |
|---|---|---|---|---|---|---|---|---|
| | BF1 | BF2 | BF with | BF with | New | New | New | New |
| | | | hot H₂ | hot H₂ | furnace | furnace | furnace | furnace |
| | | | injected | injected | with 180 | with 110 | with 180 | with 100 |
| | | | to | to | kg/tHM, | kg/tHM, | kg/tHM, | kg/tHM, |
| | | | tuyere | tuyere | without | without | with | with |
| | | | | and | shaft | shaft | shaft | shaft |
| | | | | shaft | injection | injection | injection | injection |
| Density of hot blast | 1.29 | 1.29 | N/A | N/A | N/A | N/A | N/A | N/A |
| injected to tuyere, | | | | | | | | |
| kg/Nm³ | | | | | | | | |
| Volume flow rate of | 820.8 | 740.2 | 0 | 0 | 0 | 0 | 0 | 0 |
| hot blast injected to | | | | | | | | |
| tuyere, Nm³/tHM | | | | | | | | |
| Mass flow rate of | 1056.8 | 953.0 | 0 | 0 | 0 | 0 | 0 | 0 |
| hot blast, kg/tHM | | | | | | | | |
| Density of reducing | N/A | N/A | 0.09 | 0.09 | 0.69 | 0.37 | 0.69 | 0.38 |
| gas injected to | | | | | | | | |
| tuyere, kg/Nm³ | | | | | | | | |
| Volume flow rate of | 0 | 0 | 1280 | 760 | 947 | 1200 | 760 | 889 |
| reducing gas | | | | | | | | |
| injected to tuyere, | | | | | | | | |
| Nm³/tHM | | | | | | | | |
| Mass flow rate of | 0 | 0 | 114 | 68 | 650 | 443 | 525 | 337 |
| reducing gas | | | | | | | | |
| injected to tuyere, | | | | | | | | |
| kg/tHM | | | | | | | | |
| Density of O₂, kg/Nm³ | 1.42 | | | | | | | |
| Volume flow rate of | 62.7 | 89.2 | 147.6 | 182.5 | 71.2 | 1.9 | 75.1 | 6 |
| cold O₂ injected to | | | | | | | | |
| tuyere, Nm³/tHM | | | | | | | | |
| Mass flow rate of | 90 | 127 | 210.9 | 260.7 | 101.7 | 2.7 | 107 | 9 |
| cold O₂ injected to | | | | | | | | |
| tuyere, kg/tHM | | | | | | | | |
| Total mass flow of | 1146 | 1080 | 325 | 329 | 751 | 446 | 632 | 346 |
| injected gas to the | | | | | | | | |
| tuyere, kg/tHM | | | | | | | | |

TABLE 6
Gas composition of reducing gas injected to the tuyere.

| | | Case1 | Case2 | Case3 | Case4 | Case5 | Case6 | Case7 | Case 8 |
|---|---|---|---|---|---|---|---|---|---|
| | | BF1 | BF2 | BF with | BF with | New | New | New | New |
| | | | | hot H₂ | hot H₂ | furnace | furnace | furnace | furnace |
| | | | | injected | injected | with 180 | with 110 | with 180 | with 100 |
| | | | | to | to | kg/tHM, | kg/tHM, | kg/tHM, | kg/tHM, |
| | | | | tuyere | tuyere | without | without | with | with |
| | | | | | and | shaft | shaft | shaft | shaft |
| | | | | | shaft | injection | injection | injection | injection |
| N₂ | vol.-% | | | 0.0 | 0.0 | 0.6 | 0.6 | 0.5 | 0.5 |
| CO₂ + H₂O | vol.-% | | | 0.0 | 0.0 | 4.0 | 4.1 | 4.0 | 4.2 |
| CO | vol.-% | | | 0.0 | 0.0 | 46.9 | 20.4 | 47.4 | 21.3 |
| H₂ | vol.-% | | | 100.0 | 100.0 | 45.8 | 73.8 | 45.4 | 72.9 |
| CH₄ | vol.-% | | | 0.0 | 0.0 | 2.7 | 1.1 | 2.7 | 1.1 |
| O₂ | vol.-% | | | 0.0 | 0.0 | 0.0 | 0.0 | 0.0 | 0.0 |

To estimate the effect of such a lower coke rate on the cohesive zone in terms of pressure drop, the parameters of gas entering the cohesive zone are required. This gas is the results of injected gas into the tuyere, coke combustion (if O₂ injected), coke gasification at tuyere (in case of presence of H₂O and CO₂), and produced CO by the final reduction reaction in the liquid state (FeO(I)+C(s)→Fe(I)+CO).

Iron ores are reduced to nearly 100% in the case of new furnace (cases 7 and 8) by mainly high reducing power of gas injected to the shaft and tuyere, and to a limited amount by the final reduction and coke combustion. Therefore, the volume of gas travels through the cohesive zone is significantly lower for the new furnace.

TABLE 7
Conditions of bosh gas travels through the cohesive zone (CZ) and estimated pressure drop for all cases.

| | | Case1 | Case2 | Case3 | Case 4 | Case 5 | Case6 | Case7 | Case8 |
|---|---|---|---|---|---|---|---|---|---|
| | | BF1 | BF2 | BF with | BF with | New | New furnace | New | New |
| | | | | hot H₂ | hot H₂ | furnace | with 110 | furnace | furnace |
| | | | | injected | injected | with 180 | kg/tHM, | with 180 | with 100 |
| | | | | to | to | kg/tHM, | without | kg/tHM, | kg/tHM, |
| | | | | tuyere | tuyere | without | shaft | with | with |
| | | | | | and | shaft | injection | shaft | shaft |
| | | | | | shaft | injection | | injection | injection |
| N₂ | vol.-% | 46.55 | 44.22 | 0.0 | 0.0 | 0.0 | 0.6 | 0.0 | 0.4 |
| CO₂ | vol.-% | 0 | 0 | 0.0 | 0.0 | 0.0 | 0.0 | 0.0 | 0.0 |
| CO | vol.-% | 46.13 | 47.08 | 18 | 35.0 | 55.0 | 24.6 | 57 | 25.7 |
| H₂ | vol.-% | 7.22 | 8.7 | 82 | 65.0 | 45.0 | 74.8 | 43 | 73.8 |
| H₂O | vol.-% | 0 | 0 | 0.0 | 0.0 | 0.0 | 0.0 | 0.0 | 0.0 |
| Gas | NM³/tHM | 1398 | 1332 | 1577 | 1147 | 1154 | 1294 | 966 | 969 |
| volume | | | | | | | | | |
| flow rate | | | | | | | | | |
| of bosh | | | | | | | | | |
| gas | | | | | | | | | |
| Velocity | m/tHM | 181.8 | 214.9 | 190.6 | 117.6 | 212.3 | 377.8 | 181.1 | 316.0 |
| in | | | | | | | | | |
| cohesive | | | | | | | | | |
| zone | | | | | | | | | |
| Density | kg/Nm³ | 1.16 | 1.15 | 0.3 | 0.50 | 0.73 | 0.38 | 0.75 | 0.39 |
| Mass flow | kg/tHM | 1628 | 1530 | 486 | 569 | 839 | 495 | 731 | 381 |
| rate of | | | | | | | | | |
| bosh gas | | | | | | | | | |
| Passing | m² | 14.7 | 11.9 | 15.8 | 18.7 | 10.4 | 6.5 | 10.2 | 5.9 |
| area of | | | | | | | | | |
| gas | | | | | | | | | |
| Pressure | kPa/m | 25.5 | 34.7 | 7.4 | 4.5 | 21.7 | 36.1 | 16.4 | 26.0 |
| drop in | | | | | | | | | |
| CZ | | | | | | | | | |

To estimate the pressure drop over the CZ, the inventors have assumed that the ore layers are impenetrable. Moreover, it is believed that some part of molten slag penetrates into the coke layer in the CZ and thereby clogs part of its height. Hence, this coke-ore interface layer is also considered as an impenetrable thickness. Thus, all ascending gas can only go through the remaining thickness of CZ coke layers (total coke layer height−the height of the coke-ore interface layer)

Hence, the thickness of coke layer excluding the interface layers is generally about 15 cm for running BFs (case 1 and 2). The thickness of coke-ore interface layers is assumed to be about 4 cm. As the (effective) coke layer thickness is an important factor for stable furnace operation, this value is preferably kept unchanged for all cases.

As mentioned earlier the pressure drop is a function of density and velocity (volume flow rate and composition) of the ascending gas.

As can be seen from the Table 4, the pressure drop in the CZ for Case 2 is quite higher as in Case 1 due to the lower coke rate.

New furnace for coke rate of 180 kg/t HM can be well operated as the bosh gas can travel through the CZ much smoother. Nevertheless, to decrease the coke rate to the ultimate value of 100 kg/t HM without shaft injection seems to be challenging as the pressure drop in CZ is quite high. This means that the risk of flooding is high for the Case 6.

This issue can be overcome by increasing the pressure of the blast. Higher blast pressure increases the density and lowers the volume of gas coming to the furnace. The influence of velocity on the pressure drop is much higher than density since the pressure drop is related to the square of the velocity ΔP/L∝ρ v² (see Eq. (5)). Nevertheless, higher pressure requires more expensive mechanical devices as well as higher electricity energy demand.

However, this challenge can be mitigated by shaft injection which leads to a lower volume flow rate of injected gas into the tuyere resulting in a lower pressure drop. It can be clearly seen that the pressure drop in Case 8 (new furnace) is even lower than Case 2.

Furthermore, as the pressure drop in the CZ and dripping zone is lower for the new furnace, this allows an increase of the production rate. To achieve the level of pressure drop of the conventional BF (Case 2), the production rate could be increased by 15%. Thus, once again the advantage of the shaft injection is proved in the Case 8.

The following Table 8 shows the pressure drop for Case 2 compared to Case 8 with lower and higher production rates.

| | | | Case8 | |
|---|---|---|---|---|
| | | | | New furnace with |
| | | | New furnace with | 100 kg/tHM, with |
| | | Case 2 | 100 kg/tHM, with | shaft injection, |
| | | BF2 | shaft injection | more production |
| Production rate | tHM/h | 299 | 300 | 344 |
| Gas volume flow rate of bosh gas | NM³/tHM | 1332 | 969 | 967 |
| Velocity in cohesive zone | m/t HM | 214.9 | 316.0 | 312.7 |
| Density | kg/Nm³ | 1.15 | 0.39 | 0.41 |
| Mass flow rate of bosh gas | kg/tHM | 1530 | 381 | 392 |
| Passing area of gas | m² | 14.7 | 5.9 | 5.9 |
| Pressure drop in CZ | kPa/m | 34.7 | 26.0 | 34.3 |

### Electric Heating

Electrically driven heaters can be employed for highly efficient heating of the (first) reducing gas and attain the temperatures required into the smelting furnace. Advantageously, gas in plasma state can be used as a heating means.

Electrode-based plasma torches can serve as electrically driven heaters. The plasma is ignited on the surface of at least two electrodes. The electrodes can be made of graphite. At least one of the electrodes is in high potential and at least one of the electrodes is in lower potential. Direct current and 3-phase AC plasma torches are electrode-based plasma torches.

Besides electrode-based plasma torches, there are also electrodeless plasma torches. In the latter, the plasma is inductively ignited, thus no electrodes are needed. Classical electrodeless plasma torches are microwave (MW) plasmas and radiofrequency (RF) plasma. RF plasmas are usually referred as inductively coupled plasmas (ICP).

Direct current (DC) plasma torches have low volumetric footprint.

Alternating current (AC) plasma torches, particularly 3-phase alternating current plasma torches have higher volumetric footprint, but feature other advantages: the plasma is confined to the ignition area facilitating a better control of the position of the plasma. Due to the alternating current, thereby, periodic operating mode, the electrodes are naturally cooled which limits the electrode erosion and prolongs their lifetime. Alternating current plasma torches do not require either swirl gas or magnetic coils for plasma stabilization, like direct current plasma torches, thus, the design of the torch is less complicated.

Direct current plasma torch can comprise 2 or a multiplicity of 2 electrodes (e.g. 2, 4, 6, 8, 12, 14, 16, 18, 20). A higher number of electrodes can promote higher controllability of the plasma and increase the plasma torch power.

Alternating current plasma torch, particularly the 3-phase alternating current plasma torch can comprise 3 or a multiplicity of 3 electrodes (e.g. 3, 6, 9, 12, 15, 18, 21 electrodes or more). A higher number of electrodes can promote higher controllability of the plasma and increase the plasma torch power.

Plasma torches, especially direct current plasma torches or/and alternating current plasma and/or 3-phase alternating current plasma torches of 1-10 MW, preferably 2-6 MW, most preferably 4 to 5 MW power, may be employed in the furnace as defined above.

A plasma torch can be integrated with one or more gas injectors.

Preferably, one power supply powers 1-10, 1-5, 1-3 or 1 of the at least one plasma torches.

To allow for a stable plasma operation, the power supply might be designed with a reserve capacity. The reserve capacity may be as high as 3 times, preferably 2 times or even 1.5 times the plasma power needed for operating the plasma torches. Use of multiple power supplies of <30, <20 and/or <10 MW to power multiple plasma torches (one power supply drives one or more plasma torches) is more preferable than using one unique power supply of total capacity equal to or higher than the summation of the capacities of all low-capacity power supplies. The flickering imposed to the grid by plasma torch operation fluctuation in the former case is way less severe than in the latter. Moreover, using multiple power supplies of <30, 20 or 10 MW gives better controllability and flexibility: when a power supply fluctuates or crashes, there is no disturbance propagation to the whole system and the furnace may keep running without severe issues since the other power supplies can collectively provide the power input of the crashed power supply. In addition, one or more spare power supplies can be installed online and in case of failure of a main power supply, a switching over to the spare one assures steady-state operation at full power. During the next planned maintenance shift, the repair can be done, thereby, a production loss never occurs. Yet, high number of power supplies leads to high cost, high power losses and high space requirements, thus, an optimum number of power units should be selected.

In alternating current plasma torch, particularly in 3-phase alternating current plasma torch, the electrodes can be rod-shaped. When the plasma is on, the side of the electrode placed in plasma ignition region gets eroded and the length of the electrode is shortened. The plasma torch is equipped with a mechanism that ensures that the inter-electrode gap at plasma ignition region is maintained constant by moving the electrodes inwards, towards the plasma ignition region. After a predefined minimum length, the mechanism can exchange or amend the electrodes. In embodiments, the inter-electrode gap may be adjusted between 0 and 100 mm, such as e.g. between 5 and 50 mm or about 40 mm.

Amending the electrodes is attained by connecting, for example by screwing a new electrode at the backside of the old/used electrode (opposite the side of the electrode placed in plasma ignition region). The attachment of the new electrode to the old electrode is done by an electrode gripping device while the torch is in operation.

Another possibility for amending the electrodes may be using a carbon-based paste, when plasma operation caused the graphite electrodes to gradually erode and get consumed. The carbon paste, typically a mixture of graphite and binders, may be applied to the consumed or worn-out portions of the electrodes. This paste replenishes the carbon content, extends the electrode's life, and helps maintain efficient electrical conductivity and heat transfer during the plasma operation. The addition of carbon paste to amend graphite electrodes may typically be done using a device designed to amend electrodes without interrupting the plasma process, by bringing the electrode paste column onto the consumed portion of the graphite electrode. The device containing the carbon-based paste gradually pushes the paste into the electrode column, to fill the voids left by the consumed electrode material and restores the carbon content, allowing for a controlled and precise addition of carbon paste, ensuring that the electrode's performance and efficiency are maintained throughout the plasma operation, thereby helping to extend the electrode's operational life and contributing to the overall effectiveness of the plasma operation.

In direct current plasma torch, the electrodes may have a tubular shape. During operation, the side of the tube at the plasma ignition region erode and the thickness of the electrode is shortened. A plasma torch electrode exchanging device replaces the torn electrodes to new electrodes into the plasma torch. The replacement of the used electrode with the new electrode is achieved by a further electrode gripping device.

The mechanism of electrode replacing system can be equipped with a magazine for new electrodes and a magazine for used electrodes, so the plasma torch can operate without manual interaction for a long period.

In DC plasma torch, the plasma is controlled by tuning the electrical operating parameters. In 3-phase AC plasma torch, the plasma control is based on a camera that continuously captures pictures of the plasma. The plasma characteristics depicted in those pictures (i.e. luminosity, shape, diffusivity etc.) are benchmarked against plasma pictures that depict characteristics of plasma at steady state, using a relevant software. Then, changes are imposed (i.e. inter-electrode gap, voltage amplitude etc.) in order to retain the plasma in stable regime.

In some embodiments, the gas velocity across a plasma heater comprising a plasma torch may be between 10 and 120 m/s, preferable between 20 and 50 m/s. The incoming gas flow arriving to the plasma heater may be split into at least two streams, a first stream flowing centrally through the arc created by the plasma torch and a second stream flowing peripherally around the arc. Both streams may substantially identical velocities and/or flow dynamics. It is however preferred that the two streams have different velocities and flow dynamics, such as e.g. the central flow crossing the arc being preferably a flow of low velocity (5-60 m/s) with turbulences reduced as much as possible whereas the peripheral flow is preferably a flow of high velocity (30-200 m/s) and may be arranged as a vortex flow

In some preferred embodiments, the central stream flows through the plasma arc and is heated to very high temperature. The second stream is injected shortly downstream of the plasma arc and is orientated in such way that it acts as a protection of the refractory lined walls of the plasma burner chamber of the plasma torch from the heat of the central, high temperature, stream, thereby advantageously reducing the thermal load on the wall lining.

### DETAILED DESCRIPTION OF EMBODIMENTS

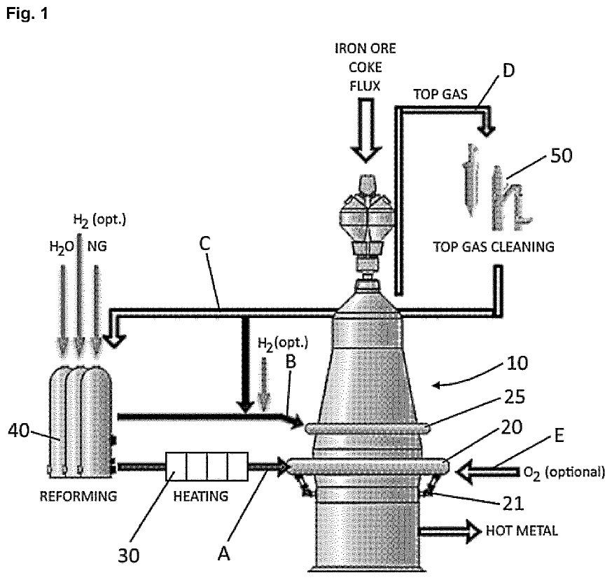

FIG. 1 present an advantageous embodiment of a smelting furnace installation according to some aspects of the disclosure, such as a blast furnace installation modified to operate according to the disclosure.

The (modified) blast furnace installation comprises a blast furnace 10 with its conventional tuyeres and tuyere stocks 21 fed by a bustle pipe 20. However, unlike conventional blast furnaces, the bustle pipe 20 provides a first reducing gas A through the tuyere stocks 21 and the tuyeres to the blast furnace 10. Furthermore, a second reducing gas B is fed through a number of injectors (not shown) at shaft level, said injectors being fed by ring pipe 25.

The first reducing gas A and the second reducing gas B preferably comprise a reforming gas obtained by reforming the blast furnace's top gas D or other gases from the metallurgical plant. Optionally, H₂ can be added to the second reducing gas B either to specifically increase the second reducing gas' hydrogen content or for adapting its temperature, such as for cooling it to the desired temperature. Reforming may be done in any appropriate reformer 40 or device operated as such, e.g. in regenerative heat exchangers as illustrated in FIG. 1, in the presence of H₂O and/or natural gas (NG) or any other appropriate source. Hydrogen can be added to reformer 40 if desired.

Prior to reforming, top gas D is preferably cleaned in top gas cleaner 50 to eliminate any solid particles and thereby provide cleaned top gas C. If desired, top gas D or cleaned top gas C can be submitted to further treatment steps before entering the reformer 40 as for example (partial) removal of specific components such as H₂O, chlorines, heavy metals, sulphur components such as COS and the like. Cleaned top gas C can also be directly (i.e. unreformed) added to the second reducing gas B.

The first reducing gas A is heated to temperatures above 1600 °C prior to injection through the tuyeres via tuyere stocks 21 into the blast furnace 10. This (additional) heating (or part of this heating) can be done through (resistance) heating device 30 before entering the bustle pipe 20. It is however preferred to heat the first reducing gas A to its desired temperature only shortly before its injection in the blast furnace 10, e.g. by plasma torches (not shown) installed on the tuyeres stocks 21, such as on the blow pipes.

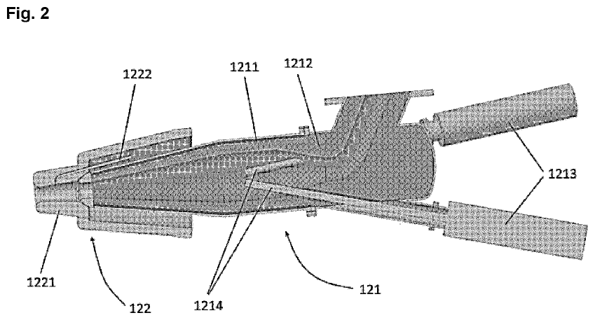

If required or desired, a small amount of oxygen E can be added at tuyere level, such as for creating and maintaining the raceway voids at the tuyeres 21 within the blast furnace 10. The (optional) oxygen E is preferably added at rather low temperatures (compared to the first reducing gas) in order to allow for cooling the tuyeres 122 (FIG. 2).

FIG. 2 generally presents a possible embodiment of an electric heater useful in the context of the present disclosure. In this embodiment, three electrode plasma torches 1213 (only two are shown due to the cut-out view) are arranged in the blowpipe 1211 of the tuyere stock 121 such that their electrodes 1214 reach within the central duct of the blowpipe 1211, which blowpipe 1211 preferably comprises a refractory lining 1212. In FIG. 2, the tuyere stock 121 is fluidly connected to the tuyere 122 positioned within the wall (not shown) of the smelting furnace, the nose 1221 of the tuyere 122 reaching within the smelting furnace. An oxygen port 1222 is advantageously arranged within the tuyere 122 setup for injecting (preferably cold) oxygen as further disclosed above.

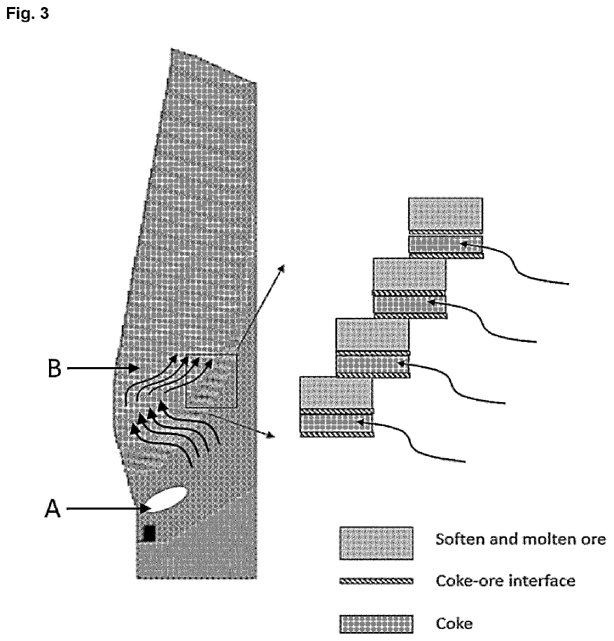

FIG. 3 shows a schematic (half-) section of a blast furnace in operation comprising stacked coke and iron ore layers fed from the top of the furnace. FIG. 3 also shows detailed views of the layers within the cohesive zone. The first reducing gas A is injected at tuyere level thereby forming a raceway due to the velocity of the gas and direct gasification of coke. The resulting gas rises within the furnace and must pass through the coke layers within the cohesive zone, where the now softened and molten iron (ore) layers in the cohesive zone have become essentially impermeable to gas. The injection of the second reducing gas B pushes the rising gas towards the center of the furnace, thereby largely preventing the wall channeling effect mentioned above.

1. A method for operating a smelting furnace installation, in particular a blast furnace installation, the method including the following steps:
feeding coke, iron oxide containing and other iron bearing material and, if required, fluxing agents to the top of the smelting furnace,
injecting a first reducing gas containing hydrogen at a tuyere level of the smelting furnace, the first reducing gas being heated at a temperature above 1600 °C, and
injecting a second reducing gas at a lower shaft level of the smelting furnace within the gas-solid reduction zone of ferrous oxide above the cohesive zone,
wherein coke is fed at a lump coke rate below 220 kg/t HM, and wherein the density of the first reducing gas is below 0.80 kg/Nm³.

2. The method as claimed in claim 1, further comprising
injecting oxygen at the tuyere level of the smelting furnace at a rate below 120 Nm³/t HM,
wherein the temperature of the injected oxygen is below 600 °C.

3. The method as claimed in claim 1, wherein the first reducing gas is injected at the tuyere level at a total mass flow below 800 kg/t HM.

4. The method as claimed in claim 1, wherein the first reducing gas and/or the second reducing gas comprise(s) a gas produced by a reforming process, by reforming coke oven gas, natural gas, biogas and/or other hydrocarbon containing gases, with H₂O, CO₂, or a CO₂ and/or H₂O containing gas and/or more preferably with a steel plant offgas such as smelting furnace top gas, basic oxygen furnace gas, and/or open bath furnace gas.

5. The method as claimed in claim 1, wherein the first reducing gas and/or the second reducing gas comprise(s) a gas produced by applying a CO₂ separation technique, such as absorption with monoethanolamine (MEA), membrane separation, Pressure Swing Adsorption (PSA) or Vacuum Pressure Swing Adsorption (VPSA) to a hydrogen and/or CO rich gas, to a steel plant gas such as smelting furnace top gas, basic oxygen furnace gas, and/or oxygen blast furnace gas.

6. The method as claimed in claim 1, wherein the first reducing gas has a hydrogen content above 30 vol.-%

7. The method as claimed in claim 1, wherein the first reducing gas is injected at a temperature from 1600 °C to 2600 °C.

8. The method as claimed in claim 1, wherein the first reducing gas is heated with one or more electric heaters before injection to the smelting furnace, within the tuyere stock(s) and/or the tuyere(s), by one or more plasma torches.

9. The method as claimed in claim 8, wherein the first reducing gas is heated with one or more plasma torches arranged within a blowpipe of the tuyere stock(s), the plasma torches being electrode-based plasma torches or electrodeless plasma torches, such as selected from inductively ignited plasma torches, microwave plasma torches, radiofrequency plasma torches or a combination thereof.

10. The method as claimed in claim 9, wherein the one or more plasma torches are direct current plasma torches and/or alternating current plasma torches and/or 3-phase alternating current plasma torches, wherein said plasma torches have an electric power rating of 1 to 10 MW.

11. The method as claimed in claim 1, wherein the first and/or the second reducing gas has a molar ratio (H₂+CO)/(H₂O+CO₂) above 6.

12. The method as claimed in claim 1, wherein the second reducing gas has a hydrogen content above 25 vol.-%.

13. The method as claimed in claim 1, wherein the second reducing gas is injected at a temperature from 800 °C to 1200 °C.

14. The method as claimed in claim 1, wherein a pressure level of the smelting furnace at the tuyere level is controlled to values above 2 barg.

15. The method as claimed in claim 1, wherein the first reducing gas and the second reducing gas have a nitrogen content below 35 vol.-%.

16. The method as claimed in claim 1, wherein the first and/or second reducing gas comprises a gas resulting from cracking ammonia.

17. The method as claimed in claim 1, wherein the coke is fed in layers and wherein the height of each coke layer is at least 10 cm.

18. The method as claimed in claim 1, further comprising a step of adjusting the average reduction degree of the iron oxide containing material reaching the cohesive zone to a value of above 85% by controlling the amount and/or composition of the second reducing gas injected at the shaft level as a function of the amount and/or composition of the first reducing gas injected at tuyere level and/or the amount of oxygen injected at tuyere level.

19. The method as claimed in claim 1, further comprising the step of reducing the channeling effect and flooding effect by controlling the top pressure of the smelting furnace in the range 1 to 10 barg.

20. The method as claimed in claim 1, further comprising the step of reducing the wall channeling effect of the gas coming from the cohesive zone by controlling the injection conditions of the second reducing gas, such as the injection speed and/or rate of the second reducing gas injected in the shaft of the smelting furnace.

21. The method as claimed in claim 1, further comprising the step of reducing the carbon dioxide content of any one or more carbon dioxide containing offgas and/or process gas produced during operation by carbon capture and utilization (CCU) and/or carbon capture and storage (CCS).

22. The method as claimed in claim 1, further comprising the step of converting carbon dioxide of any one or more carbon dioxide containing offgases produced during operation into a synthetic fuel, such as into synthetic natural gas by methanation, or into methanol and/or ethanol by methanol and/or ethanol production.

23. A smelting furnace installation, in particular a blast furnace installation, comprising
a charging apparatus configured for feeding coke, iron oxide containing and other iron bearing material and if required fluxing agents to the top of the smelting furnace;
a first injector arrangement positioned at a tuyere level of the smelting furnace and configured for injecting a first reducing gas containing hydrogen at said tuyere level of the smelting furnace at a temperature above 1600 °C; and
a second injector arrangement positioned at a shaft level of the smelting furnace and configured for injecting a second reducing gas at a lower shaft level of the smelting furnace within the gas-solid reduction zone of ferrous oxide above the cohesive zone,
wherein the charging apparatus is configured for feeding coke at a lump coke rate below 220 kg/t HM, wherein the first injector arrangement is configured for injecting the first reducing gas at a density below 0.80 kg/Nm³, at the tuyere level and wherein said first injector arrangement comprises an electric heating device configured for heating the first reducing gas at said temperature above 1600 °C.

24. The smelting furnace installation as claimed in claim 23, wherein the first injector arrangement further comprises an oxygen injection port configured for injecting oxygen at the tuyere level of the smelting furnace at a rate below 120 Nm³/t HM, wherein the temperature of the injected oxygen is preferably below 600 °C.

25. The smelting furnace installation as claimed in claim 23, wherein the first injector arrangement is configured for injecting the first reducing gas at the tuyere level at a total mass flow below 800 kg/t HM.

26. The smelting furnace installation as claimed in claim 23, further comprising one or more reformer configured for producing a gas as a first and/or second reducing gas by a reforming process, in particular by reforming coke oven gas, biogas, natural gas and/or other hydrocarbon containing gases, with H₂O and/or CO₂ or a CO₂ and/or H₂O containing gas and/or more preferably with a steel making offgas such as smelting furnace top gas, basic oxygen furnace gas, open bath furnace gas.

27. The smelting furnace installation as claimed in claim 23, further comprising one or more apparatuses configured for separation of CO₂ by a CO₂ separation process such as absorption with monoethanolamine (MEA), membrane separation, Pressure Swing Adsorption (PSA) or Vacuum Pressure Swing Adsorption (VPSA) for treating smelting furnace top gas, basic oxygen furnace gas and/or open bath furnace gas.

28. The smelting furnace installation as claimed in claim 23, further comprising a first source of hydrogen and a first hydrogen content controller configured to adjust a hydrogen content of the first reducing gas to values above 30 vol.-%.

29. The smelting furnace installation as claimed in claim 23, wherein the electric heating device of said first injector arrangement is configured for heating the first reducing gas to temperatures from 1600 °C to 2600 °C.

30. The smelting furnace installation as claimed in claim 23, wherein said electric heating device comprises one or more electric resistance heaters and/or one or more plasma torches.

31. The smelting furnace installation as claimed in claim 30, wherein said electric heating device comprises one or more plasma torches arranged within a blowpipe of the tuyere stock(s), the plasma torches being electrode-based plasma torches or electrodeless plasma torches, such as selected from inductively ignited plasma torches, microwave plasma torches, radiofrequency plasma torches, or a combination thereof.

32. The smelting furnace installation as claimed in claim 31, wherein the one or more plasma torches are direct current plasma torches and/or alternating current plasma torches and/or 3-phase alternating current plasma torches, wherein said plasma torches have an electric power rating of 1 to 10 MW.

33. The smelting furnace installation as claimed in claim 23, further comprising a second source of hydrogen and a second hydrogen content controller configured to adjust a hydrogen content of the second reducing gas above 25 vol.-%.

34. The smelting furnace installation as claimed in claim 23, wherein the first injector arrangement comprises an upstream regulation device which is configured for controlling the mass flow rate of the first reducing gas injected in the smelting furnace at the tuyere level to 800 kg/t HM at the pressure level above 2 barg.

35. The smelting furnace installation as claimed in claim 23, further comprising regulating unit configured for adjusting the average reduction degree of the iron oxide containing material reaching the cohesive zone to a value of above 85% by controlling the amount and/or composition of the second reducing gas injected through the second injector arrangement at the shaft level as a function of the amount and/or composition of the first reducing gas injected at tuyere level and/or the amount of oxygen injected through the oxygen injection port at tuyere level.

36. The smelting furnace installation as claimed in claim 23, further comprising a carbon capture and utilization (CCU) unit and/or a carbon capture and storage (CCS) unit downstream of at least one carbon dioxide containing offgas producing element for reducing the carbon dioxide content of said offgas.

37. The smelting furnace installation as claimed in claim 23, further comprising a methanation unit configured for converting carbon dioxide to synthetic natural gas and/or process gas or any other device for producing synthetic hydrocarbons such as methanol and ethanol.
